(19) United States
(12) Patent Application Publication
(10) Pub. No.: US 2025/0298199 A1
(43) Pub. Date: Sep. 25, 2025

(54) METHODS AND APPARATUS FOR WAVEGUIDE ALIGNMENT BETWEEN OPTICAL COMPONENTS

(71) Applicant: Intel Corporation, Santa Clara, CA (US)

(72) Inventors: Chia-Pin Chiu, Tempe, AZ (US); Kaveh Hosseini, Livermore, CA (US)

(21) Appl. No.: 18/615,740

(22) Filed: Mar. 25, 2024

(51) Int. Cl. G02B 6/42

(52) U.S. Cl. CPC G02B 6/4228; G02B 6/4212; G02B 6/4239

(57) ABSTRACT

Methods and apparatus are disclosed for waveguide alignment between optical components. An example apparatus includes a first component having a first surface and a first waveguide, the first component having a first magnet array on the first surface; and a second component having a second surface and a second waveguide, the second component having a second magnet array on the second surface, the first magnet array to be attracted towards the second magnet array to urge the first magnet array into alignment with the second magnet array, the first waveguide positioned to at least one of transmit or receive an optical signal to or from the second waveguide when the first magnet array is in alignment with the second magnet array.

### FIELD OF THE DISCLOSURE

This disclosure relates generally to semiconductor packages and, more particularly, to methods and apparatus for waveguide alignment between optical components.

### BACKGROUND

Interconnects facilitate the transfer of data signals between two or more circuit components. Interconnects are vital for the function of any circuit and affect the performance of a digital system. As demand for high data rate signaling increases, many electrical interconnects cannot keep up with the energy efficiency requirements for sustained bandwidths. Accordingly, optical interconnects are being explored as a viable alternative. Optical interconnects facilitate the transmission of signals from one portion of an electronic device to another using waveguides.

### BRIEF DESCRIPTION OF THE DRAWINGS

FIG. 1 is a cross-sectional view of an example assembly that includes example co-packaged integrated circuits (IC) in accordance with teachings of this disclosure.

FIGS. 2A-2B illustrate another example assembly including components having example magnet arrays in accordance with teachings of this disclosure.

FIG. 3 illustrates misalignment of the components of FIGS. 2A-2B.

FIGS. 4A-4B illustrate another example assembly including components having example keyed magnet arrays in accordance with teachings of this disclosure.

FIGS. 5A-5B illustrate another example assembly including components having example magnet arrays in accordance with teachings of this disclosure.

FIG. 6 illustrates misalignment of the components of FIGS. 5A-5B.

FIGS. 7A-7B illustrate another example assembly including components having example keyed magnet arrays in accordance with teachings of this disclosure.

FIGS. 8A-8B illustrate another example assembly including components having example magnet arrays within one or more trenches in accordance with teachings of this disclosure.

FIGS. 9A-9B illustrate another example assembly including components having example magnet arrays within one or more trenches in accordance with teachings of this disclosure.

FIGS. 10A-10B illustrate another example assembly including components having example magnet arrays within one or more trenches in accordance with teachings of this disclosure.

FIG. 11 illustrates example components of an assembly constructed in accordance with teachings of this disclosure.

FIGS. 12-15 illustrate various stages of manufacture of an example assembly including components having example magnet arrays in accordance with teachings of this disclosure.

FIGS. 16-19 illustrate various stages of manufacture of an example assembly including components having example magnet arrays in accordance with teachings of this disclosure.

FIG. 20 is a flowchart representative of an example method of manufacturing the example assemblies structure of FIGS. 1-11.

FIG. 21 is a top view of a wafer including dies that may be included in an IC package constructed in accordance with teachings disclosed herein.

FIG. 22 is a cross-sectional side view of an IC device that may be included in an IC package constructed in accordance with teachings disclosed herein.

FIG. 23 is a cross-sectional side view of an IC package that may include components having example magnet arrays in accordance with teachings disclosed herein.

FIG. 24 is a cross-sectional side view of an IC device assembly that may include an IC package constructed in accordance with teachings disclosed herein.

FIG. 25 is a block diagram of an example electrical device that may include an IC package constructed in accordance with teachings disclosed herein.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Electrical interconnects transfer data signals via electrical currents that flow through a metal wire. All metal wires hold resistance and capacitance that limit the ability of signal transfer, especially when the dimension of the wires is scaled down. Accordingly, electrical interconnects cannot keep up with the ever-increasing demand for high data rate signaling and bandwidth, nor the energy efficiency requirements for such sustained bandwidth. Optical interconnects, on the other hand, transfer data signals via photons that flow along a waveguide. A waveguide as disclosed herein is a physical structure that guides light (e.g., photons) along a path to facilitate the transfer of data from one component to another component. Optical interconnects demonstrate unparalleled long distance signaling capabilities at high rates of data transfer. As demand for high bandwidth and lower energy consumption increases, so will demand for co-packaged optics or photonics. Co-packaged optics includes the integration of optics and silicon on a single package substrate to address bandwidth and power challenges.

At least one issue with the mainstream adoption of co-packaged optics concerns ease of an assembly process. To enable the reliable transmission or routing of optical signals from a first component to a second component, waveguides of the first component must be precisely aligned with waveguides of the second component.

Current techniques for optical coupling include attaching optical fibers directly onto V-grooves etched into a photonic integrated circuit (PIC). A PIC is a chip that contains photonic components that output and/or receive data in the form of light signals. Such a technique involves a special fabrication process to create the V-grooves. Moreover, such a technique calls for very accurate V-groove dimensioning and/or positioning to ensure good alignment between an optical fiber and a PIC waveguide. With no ability for rework, any errors in this process or the V-groove dimension will lead to loss of the entire package along with the expensive silicon committed to it. This problem is exacerbated by the yield compounding effect as the number of photonic chips on a package increases.

Another technique for optical coupling includes fabricating an optical coupler (e.g., a glass coupler) with cylindrical protrusions that are attached to V-grooves of a PIC. An optical coupler is a photonic device used to transfer signals using light waves to provide coupling within or between circuits or systems. In other words, optical couplers allow for the redistribution of optical signals. While this technique facilitates easier handling of the optical fibers, it still requires accurate V-grooves on the PIC, accurate cylindrical protrusions made on the glass coupler, and precise, expansive equipment to attach the glass coupler. A new method is needed that can eliminate the V-groove process and use affordable attaching equipment.

Various terms are used herein to describe the orientation of features. In general, the attached figures are annotated with a set of axes including an x-axis, a y-axis, and/or a z-axis. The x-axis is substantially perpendicular relative to the y-axis. The z-axis is substantially perpendicular relative to each of the x-axis and the y-axis. A plane defined by the x-axis and the y-axis, referred to herein as an x-y plane, is substantially perpendicular to the z-axis. As used herein, an x-direction is a direction substantially parallel relative to the x-axis, a y-direction is a direction substantially parallel relative to the y-axis, and the z-direction is a direction substantially parallel relative to the z-axis. For purposes of explanation, example magnet arrays disclosed herein are described as being on surfaces substantially parallel to the x-y plane and substantially perpendicular to the z-axis. However, other coordinates systems with the different axes oriented in different directions relative to the surfaces of magnet arrays may also be used.

Examples disclosed herein provide techniques for self-alignment of a first component and a second component. For example, disclosed examples can facilitate self-alignment between an optical coupler and a PIC. Certain examples disclosed herein are based on controllably sculpted magnetic materials (e.g., at the nanoscale). Certain examples enable three-dimensional self-alignment between components.

Examples disclosed herein utilize magnet arrays for x-directional and y-directional alignment. For purposes of this disclosure, the x direction extends along the length of the waveguides to be aligned (e.g., along the direction light travels) and, thus, along mounting surfaces (e.g., array surfaces, connection surfaces, interfacing surfaces, etc.) between a PIC and an optical coupler being combined. The y direction corresponds to a direction perpendicular to the x-direction that is also parallel to a mounting surfaces between a PIC and an optical coupler. As used herein, a mounting surface refers to a surface on which a magnet array is manufactured. That is, the x- and y-axes define a plane parallel to the mounting surfaces, with the x axes parallel to the waveguides and the y axes transverse to the waveguides. Frequently, multiple waveguides are arranged in a linear array in the y-direction. Thus, example magnet arrays disclosed herein facilitate the lateral alignment of waveguides (e.g., in the y direction) and facilitate the axial or longitudinal alignment of waveguides (e.g., separation or spacing of the waveguides in the x direction).

To enable alignment of components in the x- and y-directions, disclosed examples utilize a technique in which a first magnet array on the first component aligns with a second magnet array on the second component. Specifically, a polarity of individual magnets on the first component is designed to match or align with an opposite polarity of corresponding magnets on the second component to create attraction forces for self-alignment.

Examples disclosed herein also enable precise alignment in the z direction, which is perpendicular to the mounting surfaces (e.g., perpendicular to the x- and y-axes). Thus, alignment in the z-direction is achieved by controlling the distance or spacing between the mounting surfaces of the PIC and the optical coupler to facilitate the vertical alignment of the waveguides (assuming the mounting surfaces (e.g., the x- and y-axes) extend horizontally). For example, alignment in the z-direction can be achieved by providing at least one magnet array on a recessed surface (e.g., within a trench) of one or both components to accommodate heights of the magnet array. In other words, the z-directional alignment relies on two reference planes instead of the magnet array heights.

Examples disclosed herein enable good alignment between waveguides in optical coupler and corresponding waveguides of a PIC, without the V-grooves and the cylindrical protrusions. For example, disclosed examples enable alignment between the glass coupler waveguides and the PIC waveguides of within one micron (μm). In some examples, misalignment between the waveguides greater that one micron can significantly degrade signal integrity.

In some examples used herein, the term “substantially” is used to describe an angular relationship between two parts that is within three degrees of the stated relationship. As used herein, the term “substantially perpendicular” encompasses the term perpendicular and more broadly encompasses a meaning whereby a first axis or component is positioned and/or oriented relative to a second axis or component at an absolute angle of no more than three degrees (3°) from absolutely perpendicular. As used herein, the term “substantially parallel” encompasses the term parallel and more broadly encompasses a meaning whereby a first axis or component is positioned and/or oriented relative to a second axis or component at an absolute angle of no more than three degrees (3°) from parallel. In some examples used herein, the term “substantially” is used to describe a value that is within 10% of the stated value.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

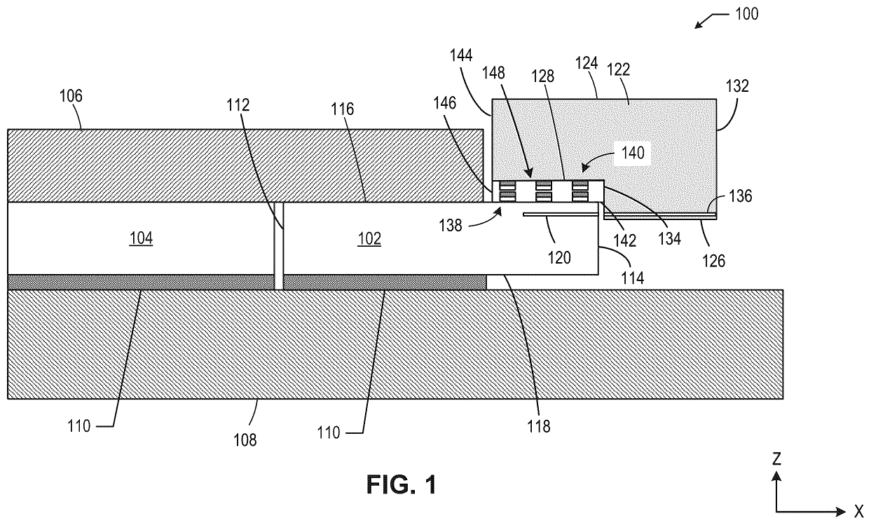

FIG. 1 is a cross-sectional view of an example IC assembly 100 (e.g., a semiconductor assembly, etc.) that includes an example photonic integrated circuit (PIC) 102 (e.g., a semiconductor component, etc.) in accordance with teachings of this disclosure. In the illustrated example of FIG. 1, the assembly 100 also includes an example electrical integrated circuit (EIC) 104. While the assembly 100 of FIG. 1 includes two ICs 102, 104, in other examples, the assembly 100 may have only one IC or more than two ICs. In some examples, the EIC 104 is omitted.

As illustrated in FIG. 1, the ICs 102, 104 are electrically coupled to an example package substrate 106. While not illustrated in FIG. 1, the package substrate 106 may be coupled to another component, such as a circuit board, an interposer, or another IC package. For example, electrical connections between the package substrate 106 and the other component, sometimes referred to as second level interconnects, may be used to conductively couple the ICs 102, 104 to the other components. For example, the second level interconnects can include solder balls (e.g., a ball grid array arrangement), pins in a pin grid array arrangement, or lands in a land grid array arrangement, etc.

In this example, the ICs 102, 104 are coupled to an example integrated heat spreader (IHS) 108. In particular, the ICs 102, 104 are coupled to the IHS 108 via a thermal interface material (TIM) 110. A TIM is a material inserted between a heat producing component and a heat dissipating component to enhance the thermal coupling between the components. The TIM 110 can be, for example, a thermally conductive adhesive tape, thermal paste, putty, gel, and/or grease, a phase-change material, a potting compound and/or liquid adhesive, liquid metal, solder, another material capable of enhancing heat transfer, and/or a combination thereof.

The PIC 102 of FIG. 1 includes a first (e.g., lateral) surface 112, a second (e.g., lateral) surface 114 opposite to the first surface 112, a third surface 116 (e.g., a first mounting surface, a first array surface, etc.) that extends between the first and second surfaces 112, 114, and a fourth surface 118 opposite the third surface 116. Each of the first and second surfaces 112, 114 of the PIC 102 are substantially perpendicular relative to an x-direction and a y-direction. In other words, the first and second surfaces 112, 114 of the PIC 102 are substantially perpendicular relative to an x-y plane. The PIC 102 is coupled to the package substrate 106 along at least a portion of the first mounting surface 116 of the PIC 102. In this example, the TIM 110 extends along a portion of the fourth surface 118 of the PIC 102. In other examples, the TIM 110 can extend along an entirety of the fourth surface 118 of the PIC 102.

The PIC 102 of FIG. 1 includes an example waveguide 120. The waveguide 120 extends along the x-direction from the second surface 114 of the PIC 102 towards the first surface 112 of the PIC 102. While one waveguide 120 is shown in the illustrated example of FIG. 1, the PIC 102 can include more than one waveguide. For example, the PIC 102 can include additional waveguides 120 that extend along the x-axis at different positions along the y-axis (not illustrated because they are positioned in front and/or behind the waveguide 120 from the perspective shown in the illustrated example).

As illustrated in FIG. 1, the PIC 102 is coupled to an example coupler component 122 (e.g., an optical coupler, a photonic coupler, a glass coupler, etc.). The coupler component 122 includes an example first surface 124 and an example second surface 126 opposite the first surface 124. The coupler component 122 of FIG. 1 also includes an example third surface 128 (e.g., a second mounting surface, a second array surface, etc.) that is recessed relative to the second surface 126. In this example, each of the first, second and third surfaces 124, 126, 128, of the coupler component 122 are substantially parallel relative to the x-direction and the y-direction. In other words, the first, second and third surfaces 124, 126, 128 of the coupler component 122 are substantially parallel relative to an x-y plane.

The coupler component 122 of FIG. 1 includes an example first lateral surface 132 that extends between the first surface 124 of the coupler component 122 and the second surface 126 of the coupler component 122. The coupler component 122 also includes a second lateral surface 134 that is substantially parallel relative to the first lateral surface 132, and which extends from the second surface 126 of the coupler component 122 to the third surface 128 of the coupler component 122. In this example, at least a portion of the second lateral surface 134 is adjacent to and faces at least a portion of the second surface 114 of the PIC 102.

The coupler component 122 of FIG. 1 includes an example (e.g., second) waveguide 136. In this example, the second waveguide 136 extends through the coupler component 122 along the x-direction from the first lateral surface 132 of the coupler component 122 to the second lateral surface 134 of the coupler component 122. Further, the second waveguide 136 is at a z-axis position that is between the second surface 126 of the coupler component 122 and the third surface 128 of the coupler component 122.

As illustrated in FIG. 1, the coupler component 122 is positioned relative to the PIC 102 such that the first waveguide 120 aligns with the second waveguide 136. For example, the first waveguide 120 is positioned to at least one of transmit or receive an optical signal to or from the second waveguide 136.

In this example, the waveguides 120, 136 have been aligned using magnets. In particular, the PIC 102 includes an example first magnet array 138, which is attracted to an example second magnet array 140 on the coupler component 122. The first magnet array 138 is disposed on the first mounting surface 116 of the PIC 102, which faces the second mounting surface 128 of the coupler component 122. Further, the second magnet array 140 is disposed on the second mounting surface 128 of the coupler component 122. As illustrated in FIG. 1, the first magnet array 138 is aligned with the second magnet array 140 in the x-direction. The first magnet array 138 is also aligned with the second magnet array 140 in the y-direction (e.g., into and out of the drawing from the perspective shown in FIG. 1).

As discussed in further detail below, the magnet arrays 138, 140 facilitate self-alignment of the PIC 102 and the coupler component 122 in the x- and y-directions. In particular, the first magnet array 138 attracts towards the second magnet array 140 to urge the first magnet array 138 into alignment with the second magnet array 140. Due to the subsequent alignment of the first and second magnet arrays 138, 140, the first waveguide 120 is positioned to at least one of transmit or receive an optical signal to or from the second waveguide 136. In other words, when the first magnet array 138 is in alignment with the second magnet array 140, the first waveguide 120 is optically aligned with the second waveguide 136.

While the magnet arrays 138, 140 facilitate alignment of the waveguides 120, 136 in the x- and y-directions, the magnet arrays 138, 140 may not facilitate alignment of the waveguides 120, 136 in a z-direction. For example, heights of the magnets 220 of the magnet arrays 138, 140 may differ due to manufacturing tolerances, etc. As discussed in further detail below, z-directional alignment can be achieved utilizing reference planes relative to the first and second components 202, 206.

For example, in the illustrated example of FIG. 1, the coupler component 122 includes an example fourth surface 142, which is substantially parallel relative to the first, second, and third surfaces 124, 126, 128 of the coupler component 122. In the illustrated examples, the fourth surface 142 extends (e.g., along the x-axis) from the second lateral surface 134 of the coupler component 122 to a third lateral surface 144 of the coupler component 122, defining a protrusion 146 extending (e.g., along the z-axis) from the second mounting surface 128 of the coupler component 122. In some examples, the lateral ends of the protrusion 146 are spaced apart from one or both of the second and third lateral surfaces 134, 144 of the coupler component 122. While not illustrated in FIG. 1, the coupler component 122 includes another protrusion 146 at a different position along the y-axis. In some examples, the magnet arrays 138, 140 are positioned between the protrusions 146. In other words, in some examples, the second mounting surface 128 is a recessed surface within a trench 148 of the coupler component 122. Positioning the second magnet array 140 on the recessed second mounting surface 128 of the trench 148 of the coupler component 122 facilitates self-alignment of the PIC 102 and the coupler component 122 in the z-direction. This facilitates z-directional alignment of the waveguides 120, 136. In this example, the fourth surface 142 of the coupler component 122 and the first mounting surface 116 of the PIC 102 define reference planes for the z-alignment. As discussed in further detail below, other reference planes can be used other examples.

Utilization of the magnet arrays 138, 140 and the recessed second mounting surface 128 provide alignment of the waveguides 120, 136 between the PIC 102 and the coupler component 122 along all three axes, without V-grooves and cylindrical protrusions. While not illustrated in FIG. 1, in some examples, an epoxy material can be disposed between the PIC 102 and the coupler component 122. For example, after alignment of the PIC 102 and the coupler component 122, an optical epoxy material can be dispensed and cured for permanent attachment. In some examples, the epoxy material is omitted so that the bonding is not permanent. In some such examples, the coupler component 122 may detach from the PIC 102.

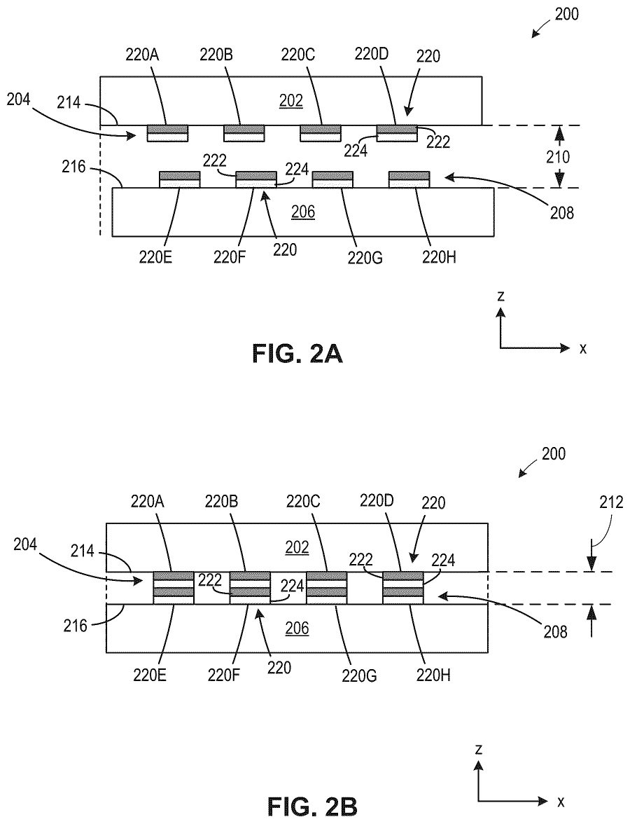

FIGS. 2A and 2B illustrate a portion of an example IC assembly 200 in accordance with teachings of this disclosure. In particular, FIGS. 2A and 2B illustrate an example first component 202 (e.g., the PIC 102, the coupler component 122, etc.) having a first magnet array 204 (e.g., a magnet array 138, 140 of FIG. 1, etc.) positioned relative to an example second component 206 (e.g., the PIC 102, the coupler component 122, etc.) having a second magnet array 208 (e.g., a magnet array 138, 140 of FIG. 1, etc.). FIG. 2A illustrates the first component 202 at a first distance 210 relative to the second component 206, and FIG. 2B illustrates the first component 202 at a second distance 212 relative to the second component 206. As shown in the illustrated examples, the first and second distances 210, 212 are defined between respective mounting surfaces 214, 216 on the first and second components 202, 206. While not illustrated in FIGS. 2A and 2B, the components 202, 206 include waveguides (e.g., similar to the waveguides 120, 136 shown in FIG. 1) that are to align to optically connect the first component 202 and the second component 206. More particularly, in some examples, the waveguides are positioned relative to the magnet arrays 204, 208 such that when the magnets are urged into alignment due to the magnetic force between them (as shown in FIG. 2B), the respective waveguides in the two components 202, 206 will also be aligned.

The first component 202 has a first (e.g., mounting) surface 214, which faces a second (e.g., mounting) surface 216 of the second component 206. As illustrated in FIGS. 2A-2B, the first magnet array 204 of the first component 202 is disposed on the first mounting surface 214 of the first component 202. Further, the second magnet array 208 of the second component 206 is disposed on the second mounting surface 216 of the second component 206. The magnet arrays 204, 208 each include a plurality of magnets 220 (e.g., magnetic structures), such as nano-magnets (e.g., magnetic nano-structures). Each magnet 220 includes a first magnetic pole 222 (e.g., a north pole) and an opposite second magnetic pole 224 (e.g., a south pole). That is, each magnet 220 includes two opposing poles. In this example, the first and second poles 222, 224 of the magnets 220 extend in a direction that is substantially perpendicular to the first and second surfaces 214, 216 (e.g., in an x-y plane with the poles 222, 224).

The magnets 220 illustrated in FIGS. 2A and 2B are referred to herein as vertical magnets because the poles 222, 224 of each magnet are stacked or aligned along the vertical axis (e.g., the z axis). The configuration of the magnet arrays 204, 208 of FIGS. 2A and 2B are also referred to herein as an out-of-plane configuration. That is, a magnet field generated by the magnet arrays 204, 208 is out-of-plane relative to the x-y plane, and relative to the first and second surfaces 214, 216. As discussed in further detail below, other configurations of magnets and magnet arrays can be used.

The first magnet array 204 of FIGS. 2A and 2B includes a first magnet 220A, a second magnet 220B, a third magnet 220C, and a fourth magnet 220D. Each of the magnets 220A-220D includes the first pole 222 coupled to the first mounting surface 214, and the second pole 224 facing towards the second mounting surface 216 of the second component 206. The second magnet array 208 of FIGS. 2A and 2B includes a fifth magnet 220E, a sixth magnet 220F, a seventh magnet 220G, and an eighth magnet 220H. Each of the magnets 220E-220H includes the second pole 224 coupled to the second mounting surface 216, and the first pole 222 facing towards the first mounting surface 214 of the first component 202. Accordingly, the magnets 220A-220D on the first component 202 attract towards the magnets 220E-220H on the second component 206 (and vice versa). In other examples, any other suitable number of magnets can be included in the magnet arrays 204, 208.

FIGS. 2A and 2B show self-alignment between the first component 202 and the second component 206 via the magnet arrays 204, 208. As illustrated in FIG. 2A, the first component 202 is offset relative to the second component 206 in at least a first direction (e.g., the x-direction). The first component 202 may also be offset relative to the second component 206 in a second direction (e.g., y-direction). In this example, the first and second directions are in a plane that is substantially parallel relative to the first mounting surface 214 of the first component 202 and the second mounting surface 216 of the second component 206.

FIG. 2B illustrates the first component 202 coupled to the second component 206 via the magnet arrays 204, 208. As the first magnet array 204 of the first component 202 and the second magnet array 208 of the second component 206 attract towards one another, the first component 202 is urged into alignment with the second component 206 in the x-direction and the y-direction. In other words, the first component 202 can be self-aligned to the second component 206 when the first and second components 202, 206 are brought close to one another. In particular, as the first component 202 approaches the second component 206, ones of the magnets 220A-220D on the first component 202 attract and connect with respective ones of the magnets 220E-220H on the second component 206. Put another way, as the first component 202 moves from the first distance 210 relative to the second component 206, towards the second distance 212 relative to the second component 206, the first component 202 aligns with the second component 206 relative the x-y plane.

The magnets 220 can be manufactured using methods of three-dimensional nanopatterning of magnetic material. For example, suitable methods include, but are not limited to, rolled-up nanotechnology, chemical deposition onto three-dimensional templates, physical vapor deposition onto self-assembled and optically written scaffolds, and direct three-dimensional nano-printing of magnetic materials by Focused Electron Beam Induced Deposition (FEBID). Among these methods, three-dimensional nano-printing presents unparalleled flexibility for rapid prototyping at the nanoscale in terms of geometry and resolution.

The magnets 220 can be manufactured to be of various shapes (e.g., cylindrical, rectangular, etc.) and sizes. In some examples, one or more of the magnets 220 can be cylindrical. In some examples, one or more of the magnets 220 can have a diameter that is approximately 5 μm. In some examples, one or more of the magnets 220 can be rectangular. For example, one or more of the magnets 220 can have a length that is approximately 5 μm, a width that is approximately 5 μm, and a height that is approximately 0.5 μm. However, the magnets 220 can have other sizes and/or shapes in other examples. In some examples, a pitch can be approximately 125 μm. However, the pitch can be more than 125 μm or less than 125 μm in other examples.

In the illustrated example of FIG. 2B, the first magnet 220A of the first component 202 is aligned with the fifth magnet 220E of the second component 206, the second magnet 220B of the first component 202 is aligned with the sixth magnet 220F of the second component 206, the third magnet 220C of the first component 202 is aligned with the seventh magnet 220G of the second component 206, and the fourth magnet 220D of the first component 202 is aligned with the eighth magnet 220H of the second component 206. It is important that the polarity of each magnet on the first component 202 matches a corresponding magnet on the second component 206 to create attraction forces for self-alignment.

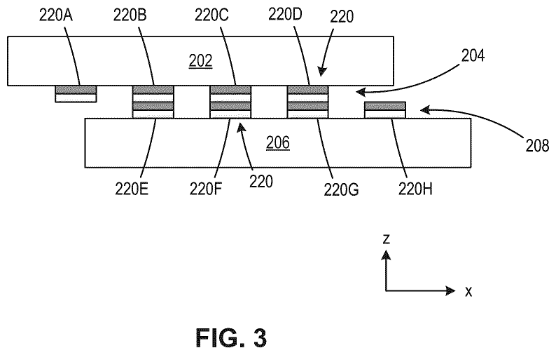

In some instances, the first component 202 and the second component 206 self-align to a target (e.g., designed, intentional, intended, etc.) position as the components 202, 206 approach one another. In the target position, ones of the magnets 220 on the first component 202 align with target ones of the magnets 220 on the second component 206. In this example, the first magnet 220A is targeted to align with the fifth magnet 220E, the second magnet 220B is targeted to align with the sixth magnet 220F, the third magnet 220C is targeted to align with the seventh magnet 220G, and the fourth magnet 220D is targeted to align with the eighth magnet 220H. However, it is possible that one or both of the components 202, 206 can shift during the self-alignment process so that the alignment is off by one pitch or more as discussed below in connection with FIG. 3.

FIG. 3 illustrates the first and second components 202, 206 of FIGS. 2A and 2B coupled via the magnet arrays 204, 208. However, the first component 202 is off-set relative to the second component 206 by one pitch. In particular, in the illustrated example of FIG. 3, the first magnet 220A of the first component 202 is not aligned with a magnet 220 on the second component 206, nor is the eighth magnet 220H of the second component 206 aligned with a magnet 220 on the first component 202. The second magnet 220B of the first component 202 is aligned with fifth magnet 220E of the second component 206, the third magnet 220C of the first component 202 is aligned with the sixth magnet 220F of the second component 206, and the fourth magnet 220D of the first component 202 is aligned with the seventh magnet 220G of the second component 206. In other words, while the polarity of each magnet on the first component 202 matches a corresponding magnet on the second component 206 to create attraction forces for self-alignment, the ones of the magnets 220 on the first component 202 do not align with targeted ones of the magnets 220 on the second component 206. In some such examples, such alignment can result in mis-alignment between waveguides in the first component 202 and the second component 206.

To avoid misalignment of the magnets 220 between the first component 202 and the second component 206, and ensure proper alignment of the waveguides within the components 202, 206, a key (e.g., a key feature, a guide, a constraint, etc.) can be added. As used herein, a key refers to a constraint on how a first magnet array can attract and align with a second magnet array. Put another way, a key in the magnet arrays restricts a manner in which a first component can self-align with a second component. In some examples, magnets arrays having a key have one way to assemble. The “keyed” nanomagnet arrays have a unique alignment between the first component and the second component. The key can be created by changing polarity (e.g., flipping or reversing the orientation) of one or more magnets and/or skipping one or more magnets in the arrays.

The magnet arrays 204, 208 of FIGS. 2A-2B and 3 are also referred to herein as non-keyed magnet arrays. In some examples, the non-keyed magnet arrays result in magnets 220 arranged in an “unstable” position so that the magnet attraction force could end up in correct alignment or mis-alignment.

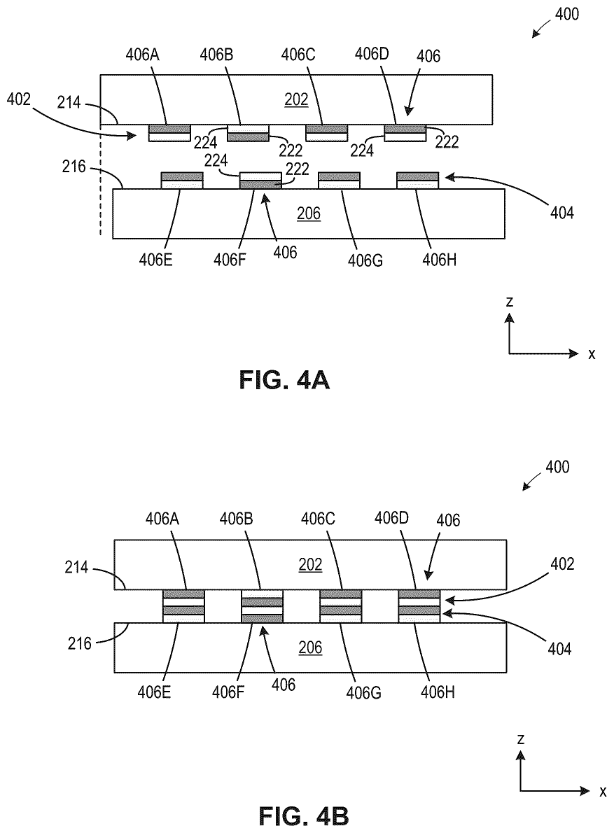

FIGS. 4A and 4B illustrate another example IC assembly 400 in accordance with teachings of this disclosure. Specifically, FIGS. 4A and 4B illustrate the example first and second components 202, 206 of FIGS. 2A-2B and 3. However, in the illustrated example of FIGS. 4A and 4B, the first component 202 includes another example first magnet array 402 and the second component 206 includes another example second magnet array 404. The magnet arrays 402, 404 each include a plurality of magnets 406, each of which include opposing poles (e.g., a first magnetic pole 222 and an opposite second magnetic pole 224).

The first magnet array 402 of FIGS. 4A and 4B includes a first magnet 406A, a second magnet 406B, a third magnet 406C, and a fourth magnet 406D. Each of the first magnet 406A, the third magnet 406C, and the fourth magnet 406D include the first pole 222 coupled to the first mounting surface 214, and the second pole 224 facing towards the second mounting surface 216 of the second component 206.

The second magnet array 404 of FIGS. 4A and 4B includes a fifth magnet 406E, a sixth magnet 406F, a seventh magnet 406G, and an eighth magnet 406H. Each of the fifth magnet 406E, the seventh magnet 406G, and the eighth magnet 406H includes the second pole 224 coupled to the second mounting surface 216, and the first pole 222 facing towards the first mounting surface 214 of the first component 202.

As opposed to the magnet arrays 204, 208 of FIGS. 2A, 2B, and 3, the first and second magnet arrays 402, 404 of FIGS. 4A and 4B include a key. In particular, the second magnet 406B of the first magnet array 402 and the sixth magnet 406F of the second magnet array 404 act as or implement the key in this example. The second magnet 406B of the first component 202 includes the second pole 224 coupled to the first mounting surface 214 of the first component 202, and the first pole 222 faces towards the second mounting surface 216 of the second component 206. The sixth magnet 406F includes the first pole 222 coupled to the second mounting surface 216, and the second pole 224 faces towards the first mounting surface 214 of the first component 202. As the first magnet array 402 of the first component 202 and the second magnet array 404 of the second component 206 attract towards one another, the first component 202 is urged into alignment with the second component in the x-direction and the y-direction. In particular, as the first component 202 approaches the second component 206, ones of the magnets 406A-406D on the first component 202 attract and connect with respective ones of the magnets 406E-406H on the second component 206.

Because the magnet arrays 402, 404 include a key, the first component 202 and the second component 206 self-align to a target position as the components 202, 206 approach one another. That is, if the components are misaligned or shifted relative to one another (similar to what is shown in FIG. 3), the first pole 222 of the second magnet 406B will be adjacent to a corresponding first pole 222 of one of the fifth, seventh, or eighth magnets 406E, 406G, 406H. Due to the same pole being brought into proximity to one another, the facing magnets will repel one another rather than be attracted towards one another. Likewise, the sixth magnet 406F will be repelled away any of the first, third, or fourth magnets 406A, 406C, 406D and will only be attracted to the second magnet 406B. As a result of the repulsion of the second and sixth magnets 406B, 406F away from any magnet other than each other, in this example, the arrays of magnets 402, 404 will be urged towards their target positions relative to one another. Accordingly, the magnet arrays 402, 404 of FIGS. 4A and 4B provide a unique self-alignment using “keyed” magnet arrays. In other words, the first and second magnet arrays 402, 404 of FIGS. 4A and 4B include magnets 406 having polarities such that the first and second magnet arrays 402, 404 are attracted toward a first arrangement (e.g., a target arrangement) relative to one another more than the first and second magnet arrays 402, 404 are attracted to a second arrangement relative to one another.

In the target position, ones of the magnets 406 on the first component 202 align with target ones of the magnets 406 on the second component 206. In this example, the first magnet 406A is targeted to align with the fifth magnet 406E, the second magnet 406B is targeted to align with the sixth magnet 406F, the third magnet 406C is targeted to align with the seventh magnet 406G, and the fourth magnet 406D is targeted to align with the eight magnet 406H. However, it is possible that one or both of the components 202, 206 can shift during the self-alignment the alignment is off by one pitch or more.

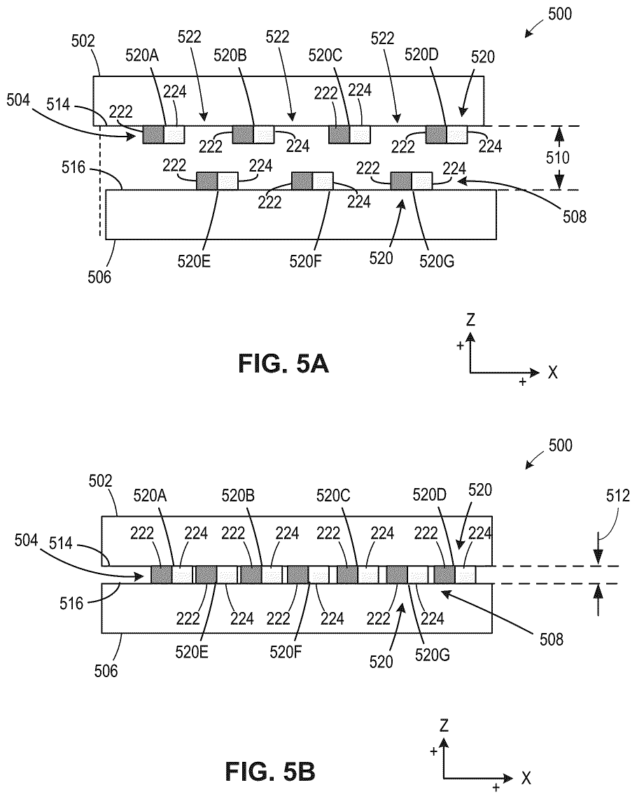

FIGS. 5A and 5B illustrate a portion of another example IC assembly 500 in accordance with teachings of this disclosure. In particular, FIGS. 5A and 5B illustrate an example first component 502 (e.g., the PIC 102, the coupler component 122, etc.) having an example first magnet array 504 positioned relative to an example second component 506 (e.g., the PIC 102, the coupler component 122, etc.) having an example second magnet array 508. FIG. 5A illustrates the first component 502 at a first distance 510 relative to the second component 506, and FIG. 5B illustrates the first component 502 at a second distance 512 relative to the second component 506. As shown in the illustrated examples, the first and second distances 210, 212 are defined between respective mounting surfaces 514, 516 on the first and second components 502, 506. While not illustrated in FIGS. 5A and 5B, the components 502, 506 include waveguides (e.g., similar to the waveguides 120, 136 shown in FIG. 1) that are to align to optically connect the first component 502 and the second component 506. More particularly, in some examples, the waveguides are positioned relative to the magnet arrays 504, 508 such that when the magnets are urged into alignment due to the magnetic force between them (as shown in FIG. 5B), the respective waveguides in the two components 502, 506 will also be aligned.

The first component 502 is similar to the first component 202 of FIGS. 2A, 2B, and 3, while the second component 506 is similar to the second component 206 of FIGS. 2A, 2B, and 3. For example, the first component 502 has a first surface 514 (e.g., a first mounting surface, a first array surface, etc.), which faces a second surface 516 (e.g., a second mounting surface, a second array surface, etc.) of the second component 506. Further, as illustrated in FIGS. 5A-5B, the first magnet array 504 of the first component 502 is disposed on the first mounting surface 514 of the first component 202, and the second magnet array 508 of the second component 506 is disposed on the second mounting surface 516 of the second component 506. Moreover, the magnet arrays 504, 508 each include a plurality of magnets 520 that include two opposing poles (e.g., a first magnetic pole 222 (e.g., a north pole) and an opposite second magnetic pole 224 (e.g., a south pole)).

As discussed above, different configurations of magnets and magnet arrays can be used. In the example of FIGS. 5A and 5B, the first and second poles 222, 224 of the magnets 520 extend in a direction that is substantially parallel to the first and second mounting surfaces 514, 516. The magnets 520 illustrated in FIGS. 5A and 5B are referred to herein as horizontal magnet arrays because the poles 222, 224 of each magnet are stacked or aligned along a horizontal axis (e.g., the x axis). In particular, the opposing poles 222, 224 of a magnet 520 face opposite directions (e.g., relative to the x-axis). In other words, the first and second poles 222, 224 of ones of the magnets 520 extend in directions substantially parallel to the mounting surfaces 514, 516. The configuration of the magnet arrays 504, 508 of FIGS. 5A and 5B is referred to herein as an in-plane configuration. That is, a magnet field generated by the magnet arrays 504, 508 is in-plane relative to the x-y plane, and relative to the first and second surfaces 514, 516.

The first magnet array 504 of FIGS. 5A and 5B includes a first magnet 520A, a second magnet 520B, a third magnet 520C, and a fourth magnet 520D. Each of the magnets 520A-520D includes both the first pole 222 and the second pole 224 coupled to the first surface 514. The second magnet array 508 of FIGS. 5A and 5B includes a fifth magnet 520E, a sixth magnet 520F, and a seventh magnet 520G. Each of the magnets 520E-520G includes both the first pole 222 and the second pole 224 coupled to the second surface 516. In other words, a first pole 222 of each magnet 520 is adjacent a corresponding second pole 224 relative to the x-axis. In other examples, any other suitable number of magnets can be included in the magnet arrays 504, 508.

FIGS. 5A and 5B show self-alignment between the first component 502 and the second component 506 via the magnet arrays 504, 508. In the illustrated example of FIG. 5A, the first component 502 is offset relative to the second component 206 in at least a first direction (e.g., the x-direction, but may also be offset relative to the second component 206 in a second direction (e.g., y-direction). In this example, the first and second directions are in a plane that is substantially parallel relative to the first surface 514 of the first component 502 and the second surface 516 of the second component 506.

As the first magnet array 504 of the first component 502 and the second magnet array 508 of the second component 506 attract towards one another, the first component 502 is urged into alignment with the second component in the x-direction and the y-direction. In other words, as the first component 502 moves from the first distance 510 relative to the second component 506, towards the second distance 512 relative to the second component 506, the first component 502 aligns with the second component 506 relative the x-y plane.

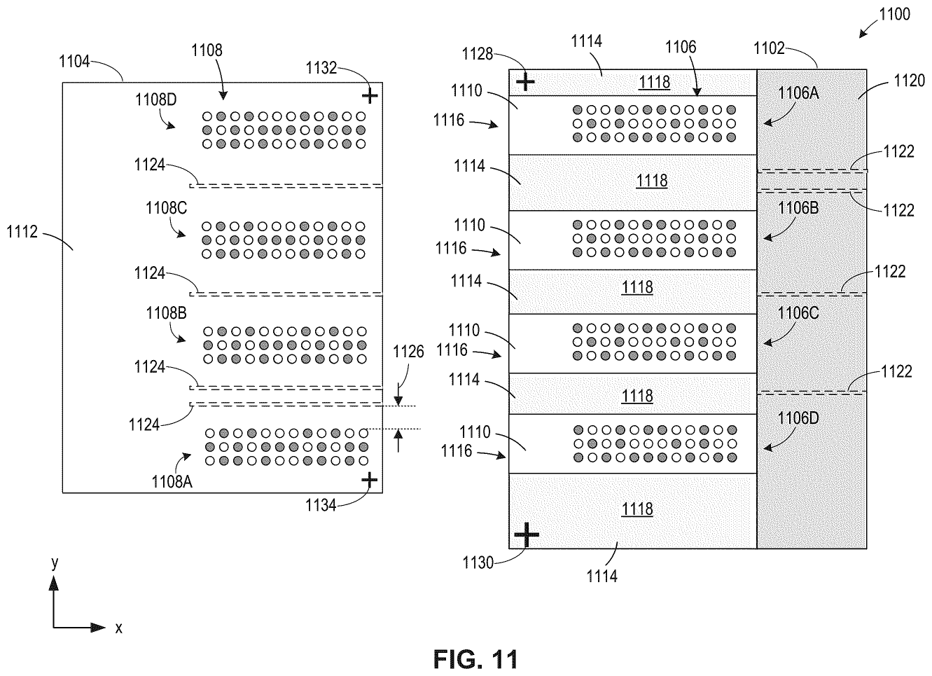

FIG. 5B illustrates the first component 502 coupled to the second component 506. As illustrated in FIG. 5B, the second pole 224 of the first magnet 520A of the first component 502 attracts towards the first pole 222 of the fifth magnet 520E of the second component 506. At the same time, the second pole 224 of the fifth magnet 520E of the second component 506 attracts towards the first pole 222 of the second magnet 520B of the first component 502. As such, the fifth magnet 520E positions itself between the first and second magnets 520A, 520B of the first component 502. That is, the fifth magnet 520E aligns adjacent the first magnet 520A as well as adjacent the second magnet 520B. While not illustrated in FIGS. 5A and 5B, the fifth magnet 520E may also align adjacent another magnet 520 that is positioned at a different y-position (shown in FIG. 11).

As illustrated in FIG. 5B, the second pole 224 of the second magnet 520B of the first component 502 attracts towards the first pole 222 of the sixth magnet 520F of the second component 506, and the second pole 224 of the sixth magnet 520F of the second component 506 attracts towards the first pole 222 of the third magnet 520C of the first component 502. As such, the sixth magnet 520F positions itself between the second and third magnets 520B, 520C of the first component 502. Moreover, the second pole 224 of the third magnet 520C of the first component 502 attracts towards the first pole 222 of the seventh magnet 520G of the second component 506, and the second pole 224 of the seventh magnet 520G of the second component 506 attracts towards the first pole 222 of the fourth magnet 520D of the first component 502. As such, the seventh magnet 520G positions itself between the second and third magnets 520C, 520D of the first component 502.

As the first magnet array 504 of the first component 502 and the second magnet array 508 of the second component 506 attract towards one another, the first component 502 is urged into alignment with the second component in the x-direction and the y-direction. In other words, the first component 502 can be self-aligned to the second component 506 when the first and second components 502, 506 are brought close to one another. In particular, as the first component 502 approaches the second component 506, ones of the magnets 520E-520G on the second component 506 attract and magnetically couple between respective ones of the magnets 520A-520D on the first component 502. Put another way, ones of the magnets 520E-520G on the second component 506 align and position in gaps 522 between ones of the magnets 520A-520D on the first component 502. As the first component 502 moves from the first distance 510 relative to the second component 506, towards the second distance 512 relative to the second component 506, the first component 502 aligns with the second component 506 relative the x-y plane.

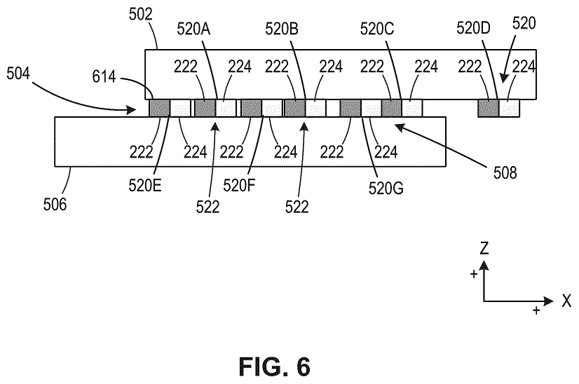

Similar to the components 202, 206 of FIGS. 2A-2B, in some instances, the first component 502 and the second component 506 self-align to a target position as the components 502, 506 approach one another. In this example, the fifth magnet 520E is targeted to align in a gap 522 between or otherwise adjacent to the first magnet 520A and the second magnet 520B, the sixth magnet 520F is targeted to align in a gap 522 between or otherwise adjacent to the second magnet 520B and the third magnet 520C, and the seventh magnet 520G is targeted to align in a gap 522 between or otherwise adjacent to the third magnet 520C and the fourth magnet 520D. However, it is possible that one or both of the components 502, 506 can shift during the self-alignment process so that the alignment is off by one pitch or more as discussed below in connection with FIG. 6.

FIG. 6 illustrates the first and second components 502, 506 of FIGS. 5A and 5B coupled via the magnet arrays 504, 508. However, the first component 502 is off-set relative to the second component 506 by one pitch. In particular, in the illustrated example of FIG. 6, the first pole 222 of the first magnet 520A of the first component 502 attracted to the second pole 224 of the fifth magnet 520E of the second component 506, and the second pole 224 of the first magnet 520A of the first component 502 attracted to the first pole 222 of the sixth magnet 520F of the second component 506. As such, the first magnet 520A positions itself in a gap 522 between the fifth and sixth magnets 520E, 520F of the second component 506. Further, the first pole 222 of the second magnet 520B of the first component 502 attracted to the second pole 224 of the sixth magnet 520F of the second component 506, and the second pole 224 of the second magnet 520B of the first component 502 attracted to the first pole 222 of the seventh magnet 520G of the second component 506. As such, the second magnet 520B positions itself in a gap 522 between the sixth and seventh magnets 520F, 520G of the first component 502. Moreover, the first pole 222 of the third magnet 520C of the first component 502 attracted towards the second pole 224 of the seventh magnet 520G of the second component 506. Accordingly, ones of the magnets 520 on the first component 502 do not align adjacent targeted ones of the magnets 520 on the second component 506. In some such examples, this can result in mis-alignment between waveguides between the first component 502 and the second component 506.

To avoid misalignment of the magnets 520 between the first component 502 and the second component 506, and ensure proper alignment of the waveguides within the components 502, 506, a key can be added. As discussed above, the key provides a constraint on how a first magnet array can attract and align with a second magnet array. The key can be created by changing polarity of some magnets (e.g., flipping or reversing the orientation) and/or skipping a magnet(s) in the arrays. The magnet arrays 504, 508 of FIGS. 5A-5B and 6 are non-keyed magnet arrays. In some examples, the non-keyed magnet arrays result in magnets 520 arranged in an “unstable” position so that the magnet attraction force could end up in correct alignment or mis-alignment.

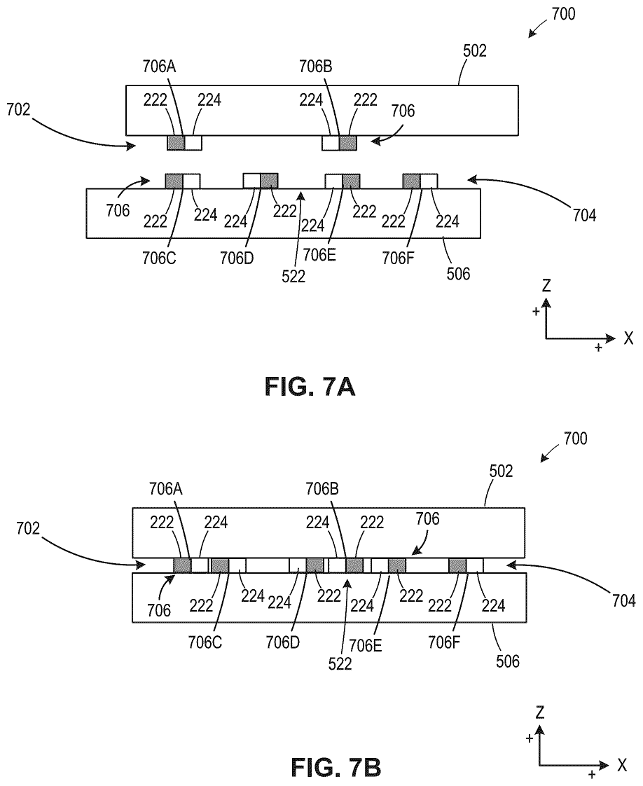

FIGS. 7A and 7B illustrate another example IC assembly 700 in accordance with teachings of this disclosure. Specifically, FIGS. 7A and 7B illustrate the example first and second components 502, 506 of FIGS. 5A-5B and 6. However, in the illustrated example of FIGS. 7A and 7B, the first component 502 includes another example first magnet array 702 and the second component 506 includes another example second magnet array 704. The magnet arrays 702, 704 each include a plurality of magnets 706, each of which include opposing poles (e.g., a first magnetic pole 222 and an opposite second magnetic pole 224). However, as opposed to the magnet arrays 504, 508 of FIGS. 5A-5B and 7, the magnet arrays 702, 704 of FIGS. 7A-7B include a key.

The first magnet array 702 of FIGS. 7A and 7B includes a first magnet 706A and a second magnet 706B. The first magnet 706A includes a first pole 222 facing a first direction (e.g., a negative (−) x-direction) and a second pole 224 facing a second direction (e.g., a positive (+) x-direction). The second magnet 706B is opposite the first magnet 706A. In particular, the second magnet 706B includes a first pole 222 facing the positive x-direction and a second pole 224 facing the negative x-direction. In other words, the second magnet 706B is opposite relative to the first magnet 706A in terms of direction of polarity.

The second magnet array 704 of FIGS. 7A and 7B includes a third magnet 706C, a fourth magnet 706D, a fifth magnet 706E, and a sixth magnet 706F. The third magnet 706C includes a first pole 222 facing the negative x-direction and a second pole 224 facing the positive x-direction. The fourth magnet 706D includes a second pole 224 facing the negative x-direction and a first pole 222 facing the positive x-direction. The fifth magnet 706E includes second pole 224 facing the negative x-direction and a first pole 222 facing the positive x-direction. The sixth magnet 706F includes a second pole 224 facing the positive x-direction and a first pole 222 facing the negative x-direction. In other words, the fourth and fifth magnets 706D, 706E are opposite the third and sixth magnets 706C, 706F in terms of direction of polarity.

In this example, the key includes both changes in polarity and skipped magnets. In particular, the first magnet array 702 includes only two magnets 706, while the second magnet array 704 includes four magnets 706. Further, the first magnet 706A on the first component 502 is spaced a relatively large distance from the second magnet 706B (e.g., relative to spaces between ones of the magnets 706 on the second component 506).

In this example, the second pole 224 of the first magnet 706A of the first component 502 is targeted to position itself adjacent the first pole 222 of the third magnet 706C of the second component 506. In fact, the first magnet 706A has the same direction of polarity as the third magnet 706C and an opposite direction of polarity as each of the fourth magnet 706D and the fifth magnet 706E. As such, the first magnet 706A would be repelled away from the fourth magnet 706D and the fifth magnet 706. Thus, the first magnet 706A would not position itself (e.g., would not be attracted to a position) between (a) the third and fourth magnets 706C, 706D of the second component 506, (b) the fourth and fifth magnets 706D, 706E of the second component 506, nor (c) the fifth and sixth magnets 706E, 706F of the second component 506.

Further, the second magnet 706B of the first component 502 is targeted to position itself in a gap 522 between or otherwise adjacent to the fourth magnet 706D of the second component 506 and the fifth magnet 706E of the second component 506. Due to the positions of the poles 222, 224 of the magnets 706C-706E on the second component 506, the second magnet 706B is attracted towards the target position and repelled away from mis-aligned positions. For example, the second magnet 706 has the same direction of the polarity as the fourth magnet 706D and the fifth magnet 706E. Further, the second magnet 706B has an opposite direction of polarity as the third magnet 706C and the sixth magnet 706F. As such, the second magnet 706B would be repelled away from the sixth magnet 706F. Thus, the second magnet 706B would not position itself between (a) the third and fourth magnets 706C, 706D of the second component 506 nor (b) the fifth and sixth magnets 706E, 706F of the second component 506. If the components are misaligned or shifted relative to one another (similar to what is shown in FIG. 6), in this example, the arrays of magnets 702, 704 will be urged towards their target positions relative to one another.

As the first magnet array 702 of the first component 502 and the second magnet array 704 of the second component 506 attract towards one another, the first component 502 is urged into alignment with the second component 506 in the x-direction and the y-direction. Because the components 502, 506 include a key, the first component 502 and the second component 506 self-align to the target position as the components 502, 506 approach one another. Accordingly, the magnet arrays 702, 704 of FIGS. 7A and 7B provide a unique self-alignment using “keyed” magnet arrays.

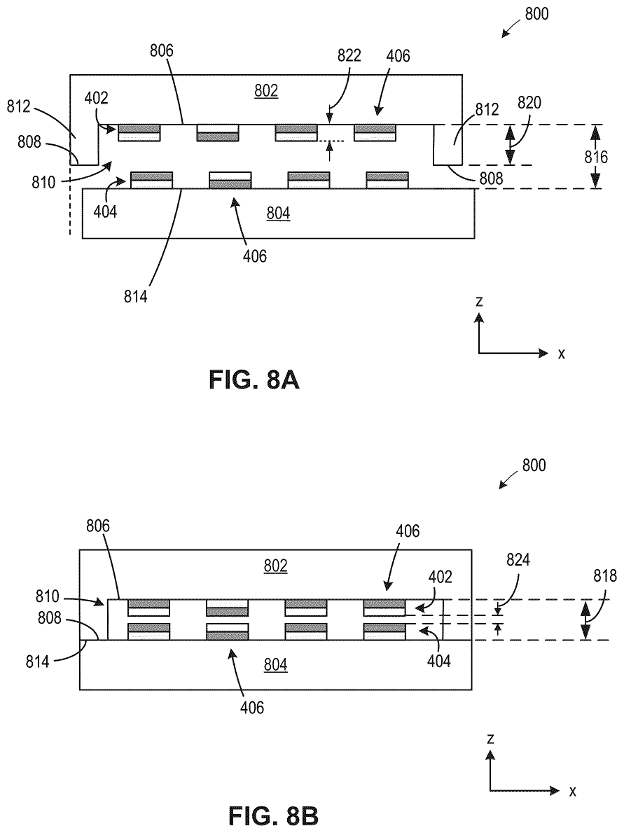

In the examples of FIGS. 2A-2B, 3, 4A-4B, 5A-5B, 6, and 7A-7B, the distance between a first component 202, 502 and a second component 206, 506 is determined by a height of corresponding magnet arrays 204, 208, 402, 404, 504, 508, 702, 704, which can vary due to manufacturing tolerances. To accurately align in the components 202, 206, 502, 506 in a z-direction, a trench can be generated within one or both components 202, 206, 502, 506, as discussed further in connection with FIGS. 8A and 8B.

FIGS. 8A and 8B illustrate a portion of another example IC assembly 800 in accordance with teachings of this disclosure. In particular, FIGS. 8A and 8B illustrate three-dimensional self-alignment of an example first component 802 (e.g., the PIC 102, the coupler component 122, etc.) having a first magnet array 402 and an example second component 804 (e.g., the PIC 102, the coupler component 122, etc.) having a second magnet array 404. For the sake of simplicity and illustrative purposes, the first and second components 802, 804 of this example include the keyed first and magnet arrays 402, 404 of FIG. 4. However, the first and second components 802, 804 can include other magnet arrays in other examples.

The first component 802 has a first surface 806 (e.g., a first mounting surface, a recessed surface, a first array surface, etc.) and a second surface 808 that is substantially parallel relative to the first surface 806. The first surface 806 of the first component 802 of FIG. 8 is recessed relative to the second surface 808. In particular, an example trench 810 (e.g., cavity, etc.) is fabricated into the second surface 808 of the first component 802. For example, the trench 810 can be formed using a drilling process (e.g., mechanical drilling, laser drilling, etc.), an etching technique, and/or another suitable method to generate a cavity in a substrate. The trench 810 extends from the second surface 808 of the first component 802 to the first surface 806 of the first component 802. The fabrication of the trench 810 forms example protrusions 812 that extend from the second surface 806 of the first component 802 on lateral sides of the first magnet array 402.

The first and second surfaces 806, 808 of the first component 802 face a third surface 814 (e.g., a second mounting surface, a second array surface, etc.) of the second component 804. As illustrated in FIGS. 8A-8B, the first magnet array 404 of the first component 802 is disposed on the recessed first mounting surface 806 of the first component 802, and the second magnet array 404 of the second component 804 is disposed on the second mounting surface 814 of the second component 804. While not illustrated in FIGS. 8A and 8B, the components 802, 804 include waveguides (e.g., similar to the waveguides 120, 136 shown in FIG. 1) that are to align to optically connect the first component 802 and the second component 804. More particularly, in some examples, the waveguides are positioned relative to the magnet arrays 402, 404 such that when the magnets 406 are urged into alignment due to the magnetic force between them (as shown in FIG. 8B), the respective waveguides in the two components 802, 804 will also be aligned.

FIGS. 8A and 8B show self-alignment between the first component 802 and the second component 804. FIG. 8A illustrates the first component 802 at a first distance 816 relative to the second component 804, and FIG. 8B illustrates the first component 802 at a second distance 818 relative to the second component 804. In this example, the first and second distances 816, 818 are defined between respective mounting surfaces 806, 814 on the first and second components 802, 804. As the first magnet array 404 of the first component 802 and the second magnet array 404 of the second component 804 attract towards one another, the first component 802 is urged into alignment with the second component 804 in the x-direction and the y-direction. In other words, the magnet arrays 402, 404 are used to facilitate x- and y-directional alignment between the first component 802 and the second component 804. However, the magnets 406 of the magnet arrays 402, 404 can have different sizes (e.g., height, length, width, circumference, etc.) due to manufacturing tolerances. As such, the magnet arrays 402, 404 in the example of FIGS. 8A and 8B are not used to facilitate z-directional alignment between the first component 802 and the second component 804. Rather, in the example of FIGS. 8A and 8B, two reference planes are used to facilitate z-directional alignment. In particular, the two reference planes include the second surface 808 of the first component 802 and the third surface 814 of the second component 804.

In the illustrated example of FIGS. 8A and 8B, the protrusions 812 formed by the trench 810 are used to control z-alignment between the first component 802 and the second component 804. The trench 810 has a depth 820 that is larger than a height 822 of any of the magnets 406. More particularly, in this example, the depth 820 of the trench 810 is greater than the combined height of matching magnets in the two interfacing arrays 402, 404. Because the depth 820 of the trench 810 corresponds to a height of the protrusions 812, the protrusions 812 are taller than any of the magnets 406 of the magnet arrays 402, 404. That is, the trench 810 is used to accommodate the heights 822 of the magnets 406 and enable z-directional alignment using the two reference planes (e.g., the second surface 808 and the third surface 814). In other words, a distance 816, 818 between the first component 802 and the second component 804 is not determined by a size(s) of the magnet arrays 402, 404, but rather by the reference planes.

FIG. 8B illustrates the first component 802 coupled to the second component 804. As illustrated in FIG. 8B, when the first component 802 is coupled to the second component 804, an example gap 824 (e.g., a space, etc.) can form between the first magnet array 402 and the second magnet array 404. In some examples, the magnet arrays 402, 404 are designed and manufactured in such a way that the magnets 406 of the magnet arrays 402, 404 do not to touch each other. In other examples, one or more magnets 406 can abut such that the first surface 806 of the first component 802 still abuts the third surface 814 of the second component 804.

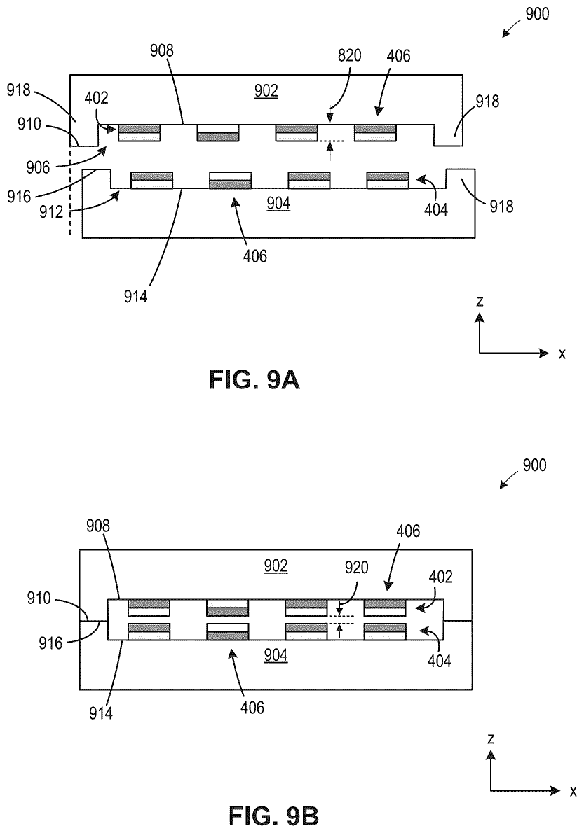

While the first component 802 includes the trench 810 in the example of FIGS. 8A and 8B, in other examples, the second component 804 can include a trench. For example, the second component 804 can include the trench 810 to facilitate z-directional alignment between the components 802, 804, and the first component 802 can include a substantially flat mounting surface. As discussed in further in connection with FIGS. 9A and 9B, in other examples, both component 802, 804 can include a trench.

Moreover, while the example of FIGS. 8A and 8B illustrate z-directional alignment using vertical magnet arrays, this technique can be used for vertical magnet arrays in other examples. For example, trenches can be added to the components 502, 506 of FIGS. 5A-5B, 6, and/or 7A-7B. In other words, z-directional alignment using two references planes can be used in out-of-plane configurations and in-plane configurations.

FIGS. 9A and 9B illustrate a portion of another example IC assembly 900 in accordance with teachings of this disclosure. In particular, FIGS. 9A and 9B illustrate three-dimensional self-alignment between an example first component 902 (e.g., the PIC 102, the coupler component 122, etc.) and an example second component 904 (e.g., the PIC 102, the coupler component 122, etc.). As illustrated in FIGS. 9A and 9B, the first component 902 has a first magnet array 402 and the second component 904 has a second magnet array 404. For the sake of simplicity and illustrative purposes, the first and second components 902, 904 of this example includes the keyed first and magnet arrays 402, 404 of FIG. 4. However, the first and second components 902, 904 can include other magnet arrays in other examples.

The first and second components 902, 904 of FIGS. 9A and 9B are similar to the first and second components 802, 804 of FIGS. 8A and 8B. However, in the example of FIGS. 9A and 9B, each component 902, 904 includes a respective trench to facilitate z-directional alignment. In particular, the first component 902 includes a first trench 906 that extends from a first surface 908 (e.g., a first mounting surface, a first recessed surface, a first array surface, etc.) of the first component 902 to a second surface 910 (e.g., a first protruded surface, etc.) that is substantially parallel relative to the first surface 908. The second component 904 includes a second trench 912 that extends from a third surface 914 (e.g., a second mounting surface, a recessed surface, a second array surface, etc.) and a fourth surface 916 (e.g., a second protruded surface, etc.) that is substantially parallel relative to the third surface 914. In other words, the first surface 908 of the first component 902 is recessed relative to the second surface 910 of the first component 902, and the third surface 914 of the second component 904 is recessed relative to the fourth surface 916 of the first component 904. The trenches 906, 912 can be formed using a drilling process (e.g., mechanical drilling, laser drilling, etc.), an etching technique, and/or another suitable method to generate a cavity in a substrate. The fabrication of the trenches 906, 912 forms example protrusions 918 that extend from the mounting surfaces 908, 914.

As illustrated in FIGS. 9A and 9B, the first magnet array 404 of the first component 902 is disposed on the recessed first mounting surface 908 of the first component 902, and the second magnet array 404 of the second component 904 is disposed on the second mounting surface 914 of the second component 904. While not illustrated in FIGS. 9A and 9B, the components 902, 904 include waveguides (e.g., similar to the waveguides 120, 136 shown in FIG. 1) that are to align to optically connect the first component 902 and the second component 904. More particularly, in some examples, the waveguides are positioned relative to the magnet arrays 402, 404 such that when the magnets 406 are urged into alignment due to the magnetic force between them (as shown in FIG. 9B), the respective waveguides in the two components 902, 904 will also be aligned.

FIGS. 9A and 9B show three-dimensional self-alignment between the first component 902 and the second component 904. As the first magnet array 404 of the first component 902 and the second magnet array 404 of the second component 904 attract towards one another, the first component 902 is urged into alignment with the second component 804 in the x-direction and the y-direction. Similar to the example of FIGS. 8A and 8B, two references planes are used to facilitate z-directional alignment. However, in the example of FIGS. 9A and 9B, the two reference planes include the second surface 910 (e.g., the first protruded surface) of the first component 902 and the fourth surface 916 (e.g., the second protruded surface) of the second component 904.

FIG. 9B illustrates the first component 902 coupled to the second component 904. The first protruded surface 910 abuts the second protruded surface 916 when the components 902, 904 are coupled. As illustrated in FIG. 9B, when the first component 902 is coupled to the second component 904, an example gap 920 (e.g., a space, etc.) can form between the first magnet array 402 and the second magnet array 404. In some examples, the magnet arrays 402, 404 are designed and manufactured in such a way that the magnets 406 of the magnet arrays 402, 404 do not to touch each other. In other examples, one or more magnets 406 can abut such that the first protruded surface 910 of the first component 902 still abuts the second protruded surface 916 of the second component 904. In other words, the trenches 906, 912 are used to accommodate the heights 822 of the magnets 406 and enable z-directional alignment using the two reference planes (e.g., the first and second protruded surfaces 910, 916).

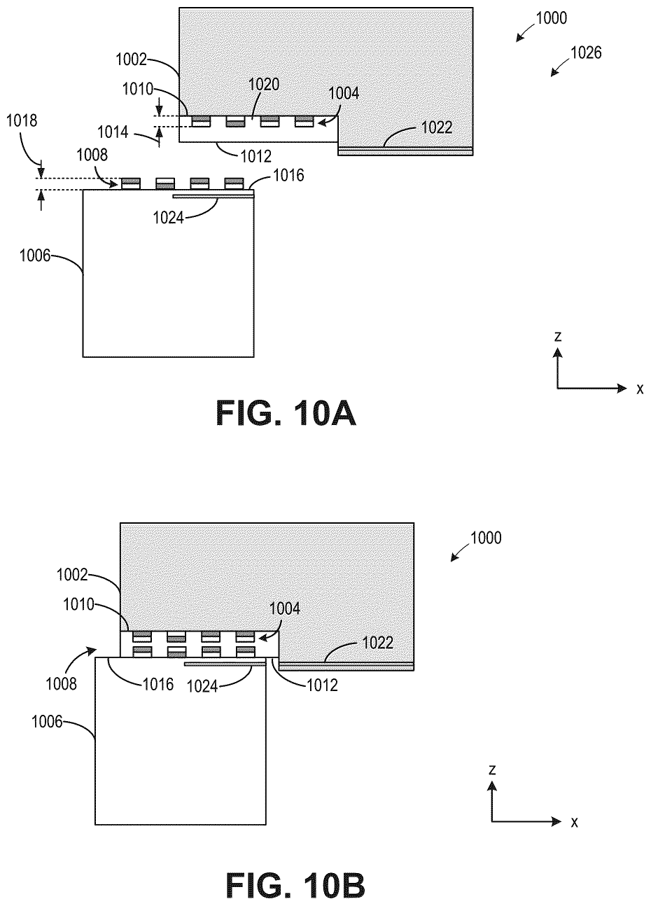

FIGS. 10A and 10B illustrate a portion of another example IC assembly 1000 in accordance with teachings of this disclosure. In particular, FIGS. 10A and 10B illustrate an example first component 1002 (e.g., the PIC 102 of FIG. 1, the coupler component 122 of FIG. 1, etc.) having an example first magnet array 1004 positioned relative to an example second component 1006 (e.g., the PIC 102 of FIG. 1, the coupler component 122 of FIG. 1, etc.) having an example second magnet array 1008. In this example, the magnet arrays 1004, 1008 are keyed, vertical magnet arrays (e.g., similar to the magnet arrays 402, 402 of FIGS. 4A-4B, 5, 8A-8B, and 9A-9B). However, the components 1002, 1006 can include other magnet arrays in other examples.

The first component 1002 has a first surface 1010 (e.g., a first mounting surface), which is recessed relative to a second surface 1012 of the first component 1002. In this example, the second surface 1012 of the first component 1002 is utilized as a reference plane for z-directional alignment. The first magnet array 1004 is disposed on the first mounting surface 1010, and has a first height 1014. For example, the first height 1014 can correspond to a tallest magnet in the first magnet array 1004. The second component 1006 has a third surface 1016 (e.g., a second mounting surface), which is utilized as a reference plane for z-directional alignment. The second magnet array 1008 is disposed on the second mounting surface 1016, and has a first height 1018. For example, the first height 1014 can correspond to a tallest magnet in the first magnet array 1004. The first component 1002 includes an example trench 1020 extending from the second surface 1012 to the first surface 1010 to accommodate the heights 1014, 1018 of the magnet arrays 1004, 1008.

As illustrated in FIGS. 10A and 10B, the first component 1002 includes a first waveguide(s) 1022 (e.g., the waveguide(s) 120, 136 of FIG. 1) and the second component 1006 includes a second waveguide(s) 1024 (e.g., the waveguide(s) 120, 136 of FIG. 1). The waveguides 1022, 1024 are to align to optically connect the first component 1002 and the second component 1006. More particularly, the waveguides 1022, 1024 are positioned relative to the magnet arrays 1004, 1008 such that when magnet arrays 1004, 1008 are urged into alignment due to the magnetic force between them (as shown in FIG. 10B), the respective waveguides 1022, 1024 in the two components 1002, 1006 will also be aligned.

As illustrated in FIG. 10A, the first component 1002 is at a first position 1026 relative to the second component 1006. In the first position 1026, the first component 1002 is offset relative to the second component 1006 in multiple directions (e.g., the x-direction, the y-direction, the z-direction). FIG. 10B illustrates the first component 1002 coupled to the second component 1006. As illustrated in FIGS. 10 and 10B, the first component 1002 can be self-aligned to the second component 1006 when the components 1002, 1006 are brought close to one another. In particular, the magnet arrays 1004, 1008 enable alignment of the components 1002, 1006 and the waveguides 1022, 1024 in both the x- and y-directions. The two reference planes (e.g., the second surface 1012 of the first component 1002 and the third surface 1016 of the second component 1006) are designed in such a way that when the two reference planes 1012, 1016 touch each other, the waveguide(s) 1022 in the first component 1002 aligns with the waveguide(s) 1024 in the second component 1006 in the z-direction.

FIG. 11 illustrates a portion of another example IC assembly 1100 including an example first component 1102 and an example second component 1104 in accordance with teachings of this disclosure. In particular, FIG. 11 illustrates an example distribution of example first magnet arrays 1106 positioned on the first component 1102 and example second magnet arrays 1108 positioned on the second component 1104. As illustrated in FIG. 11, the first component 1102 is flipped or rotated from an attachment position so that the magnet arrays 1106, 1108 are visible and facing out of the drawing for illustrative purposes.

In this example, the first component 1102 includes a first magnet array 1106A, a second magnet array 1106B, a third magnet array 1106C, and a fourth magnet array 1106D, while the second component 1104 includes a fifth magnet array 1108A, a sixth magnet array 1108B, a seventh magnet array 1108C, and an eighth magnet array 1108D. However, the components 1102, 1104 can include different amounts of magnet arrays 1106, 1108 in other examples. For example, the illustrative example of FIG. 11, each component 1102, 1104 includes four magnet arrays 1106, 1008. In other examples, the first component 1102 and/or the second component 1104 can include less than four magnet arrays 1106, 1108 or more than four magnet arrays 1106, 1108. Further, the magnet arrays 1106, 1108 can include different amounts of magnets and/or different distributions or configuration in other examples. In some instances, one or more magnet arrays 1106, 1108 can include less than one hundred magnets. In other instances, one or more magnet arrays 1106, 1108 can include hundreds to thousands of magnets.

The first magnet arrays 1106 are positioned on respective second surfaces 1110 (e.g., second mounting surfaces) of the first component 1102. The second magnets arrays 1108 are positioned on a second surface 1112 (e.g., a second mounting surface) of the second component 1104. In this example, the second surface 1112 of the second component 1104 implements a reference plane for z-directional alignment. The first mounting surfaces 1110 of the first component 1102 are recessed relative to third surfaces 1114 of the first component 1102. In other words, trenches 1116 are formed in the first component 1102 that extend from ones of the third surfaces 1114 to ones of the first surfaces 1110. Example protrusions 1118 are thus formed on lateral sides of the first magnet arrays 1106. In this example, the third surfaces 1114 implement a reference plane for z-directional alignment. That is, the third surfaces 1114 of the first component 1102 are to abut the second surface 1112 of the second component 1104 to facilitate z-directional alignment of the components 1102, 1104.

The magnet arrays 1106, 1108 of this example are keyed. Ones of the first magnet arrays 1106 are targeted to align with respective ones of the second magnet arrays 1108 in a particular manner. In this example, when first component 1102 is flipped over from the orientation shown in FIG. 11 to enable the magnetic arrays to be aligned, the first magnet array 1106A of the first component 1102 is targeted to align with the fifth magnet array 1108A. The first magnet array 1106A is printed in such a manner that magnets of the first magnet array 1106A will align and coupled with specific magnets of the fifth magnet array 1108A in only the target position. Similarly, the second magnet array 1106B of the first component 1102 is targeted to align with the sixth magnet array 1108B in a target position, the third magnet array 1106C of the first component 1102 is targeted to align with the seventh magnet array 1108C in a target position, and the fourth magnet array 1106D of the first component 1102 is targeted to align with the eighth magnet array 1108D in a target position. As such, during an assembly process, the first component 1102 will self-align with the second component 1104 in the x-direction and y-direction based on the magnet arrays 1106, 1108.

In this example, the first component 1102 also includes a fourth surface 1120 that extends from the third surfaces 1114. In particular, the third surfaces 1114 are recessed relative to the fourth surface 1120. The first component 1102 of FIG. 11 includes example first waveguides 1122 that are recessed relative to the fourth surface 1120 of the second component 1104. In particular, the first waveguides 1122 are positioned between the third surfaces 1114 and the fourth surface 1120 of the first component 1102. The second component 1104 of FIG. 11 includes example second waveguides 1124 that are recessed relative to the second mounting surface 1112. As illustrated in FIG. 11, the components 1102, 1104 can include one or more waveguides 1122, 1124 between or otherwise adjacent to ones of the magnet arrays 1106, 1108. While FIG. 11 illustrates at most two waveguides 1122, 1124 adjacent the magnet arrays 1106, 1108, more than two waveguides can be disposed adjacent the magnet arrays 1106, 1108 in other examples.

Further, the magnet arrays 1106, 1108 of FIG. 11 are positioned to avoid interaction with the waveguides 1122, 1124 to reduce (e.g., minimize) the impact on the insertion loss. For example, if a magnetic field caused by the magnet arrays 1106, 1108 is too close to a waveguide(s) 1122, 1124, a component 1102, 1104 may experience a reduction signal power. In particular, each waveguide 1122, 1124 is positioned at least a distance 1126 away from an adjacent magnet array 1106, 1108 such that insertion loss in reduced (e.g., below a threshold value, etc.). In some examples, the distance 1126 is approximately 5 μm. However, the distance 1126 can be more or less than 5 μm (e.g., 3 μm, 10 μm, 15 μm, etc.) in other examples.

As illustrated in FIG. 11, the first component 1102 includes an example first fiducial 1128 (e.g., reference, marker, etc.) and an example second fiducial 1130 (e.g., reference, marker, etc.), each of which is positioned on a third surface 1114 of the second first component 1102. The second component 1104 includes an example third fiducial 1132 (e.g., reference, marker, etc.) and an example fourth fiducial 1134 (e.g., reference, marker, etc.) on the second surface 1112 of the second component 1006. The fiducials 1128-1134 can be used by placement equipment (e.g., a pick-and-place machine, etc.) during an assembly process of an IC assembly 1100 to aid in alignment between the components 1102, 1104. For example, the placement equipment can be used to initially bring the first component 1102 towards the second component 1104. When the first and second components 1102, 1104 are in close proximity (e.g., within half the distance between adjacent ones of the magnets), magnetic forces of the magnet arrays 1106, 1108 can take over the assembly (e.g., alignment) process. In some instances, the magnet arrays 1106, 1108 are manufactured based on the fiducials 1128-1134. In some examples, the magnet arrays 1106, 1108 are referenced by the waveguides 1122, 1124 such that the waveguides 1122, 1124 will be aligned in both x- and y-directions after assembly. The reference planes (e.g., the second surface 1112 of the second component 1104 and the third surfaces 1114 of the first component 1102) for z alignment may also be implemented to ensure the waveguides 1122, 1124 well aligned in the z-direction.

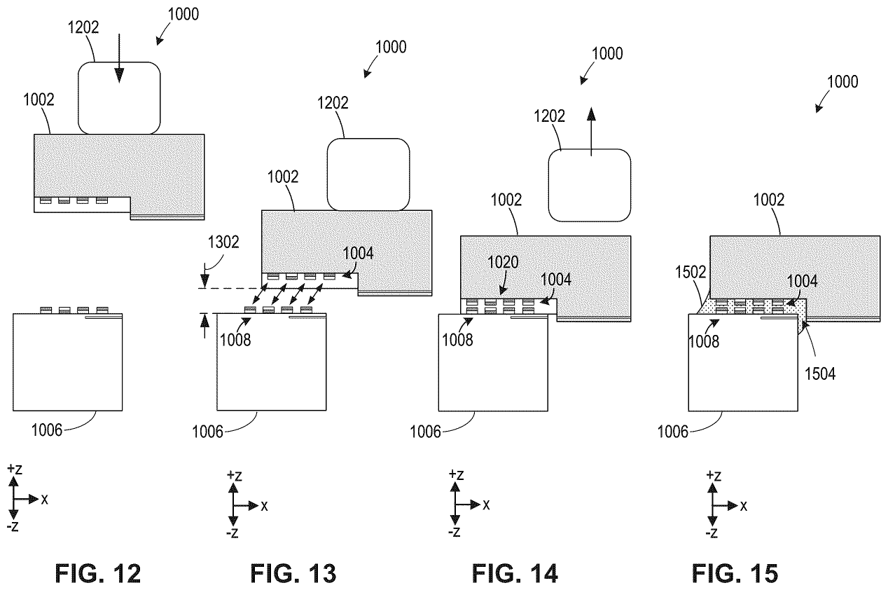

FIGS. 12-15 illustrate various stages of an example method to manufacture an example IC assembly 100, 200, 400, 500, 700, 800, 900, 1000, 1100 disclosed herein. For purposes of explanation, the various stages of FIGS. 12-15 will be described primarily with reference to the IC assembly 1000 of FIGS. 10A and 10B. However, the following discussion applies similar to any other IC assemblies structured in accordance with teachings disclosed herein.

FIG. 12 illustrates an example pick-and-place head 1202 coupled to an example first component (e.g., the first component 1002 of FIGS. 10A and 10B). In this example, the pick-and-place head 1202 is a vacuum head, but can be another type of pick-and-place head 1202 in other examples. The vacuum head 1202 is used to pick up the first component 1002 and move the first component 1002 towards an example second component (e.g., the second component 1006 of FIGS. 10A and 10B). For example, the vacuum head 1202 can utilize a vacuum force to hold and move the first component 1002.

FIG. 13 illustrates the assembly 1000 after the vacuum head 1202 has begun to move the first component 1002 towards the second component 1006. The vacuum head 1202 can move the first component 1002 in one or more directions. For example, the vacuum head 1202 head may move the first component 1002 in the x-direction, the y-direction, and/or the z-direction. In some examples, the vacuum head 1202 moves the first component 1002 within approximately one-half pitch (e.g., in the x-y plane) of the first magnet array 1004 from an alignment target (e.g., the second magnet array 1008). For example, if the magnet array 1004 has a pitch of 10 microns (μm), the first component 1002 can be moved within +/−5 μm of the second magnet array 1006. In some instances, the movement of the first component 1002 in the x- and y-directions is based on fiducials (e.g., the fiducials 1128-1134 of FIG. 11) positioned on the components 1002, 1006.

In some examples, the vacuum head 1202 moves the first component 1002 towards the second component 1006 (e.g., in the negative z-direction). For example, the vacuum head 1202 may move the first component 1002 in the negative z direction until the first component 1002 is a distance 1302 from the second component 1006 in the z-direction. For example, the distance 1302 can be a distance such that the first component 1002 will attract towards the second component 1006. In some examples, the distance 1302 is approximately between 2 μm and 5 μm. However, the distance 1302 can be higher or lower in other examples. For example, the distance 1302 can be dependent on sizes of the magnets in the magnet array(s) 1004, 1008, sizes of the magnet arrays 1004, 1008, sizes of the components 1002, 1006, etc. When the first component 1002 is the distance 1302 relative the second component 1006, the vacuum head 1202 is to release the first component 1002 (illustrated in FIG. 14). When the vacuum head 1202 releases the first component 1002, magnetic and gravitational forces act upon the first component 1002 to cause the first component 1002 to align and couple to the second component 1006.

FIG. 14 illustrates the assembly 1000 after the vacuum head 1202 releases the first component 1002. In particular, the vacuum head 1202 releases the first component 1002 to allow the first component 1002 to self-align with the second component 1006 by magnetic force and gravity force. Upon release of the first component 1002, the vacuum head 1202 may be moved in the +z direction. As illustrated in FIG. 14, the first component 1002 self-aligns with the second component 1006 is the x-direction and the y-direction via the magnet arrays 1004, 1008, and in the z-direction via the trench 1020 and the references planes discussed in connection to FIGS. 10A and 10B.

FIG. 15 illustrates the assembly 1000 after deposition of an example optical epoxy material 1502. The optical epoxy material 1502 can be dispensed and cured. In doing so, the first component 1002 can be permanently attached to the second component 1006. In some examples, the optical epoxy material 1502 is deposited between adjacent magnets 406 of the magnet array 1004, 1008. Due to the epoxy material 1502, even if the magnetic force degrades over time (e.g., through thermal cycles or environmental changes), such changes will have little to no impact on the attachment between the component 1002, 1006. In other words, in some examples, the magnetic force between the magnet arrays 1004, 1008 is used for the initial alignment, and the epoxy material 1502 provides long-term bonding force.

In some examples, the epoxy material 1502 is dispensed to fill a gap 1504 between the waveguides 1022, 1024 to reduce insertion loss. In some examples, the optical epoxy material 1502 is omitted. In some such examples, the first component 1002 is removably coupled to the second component 1006.

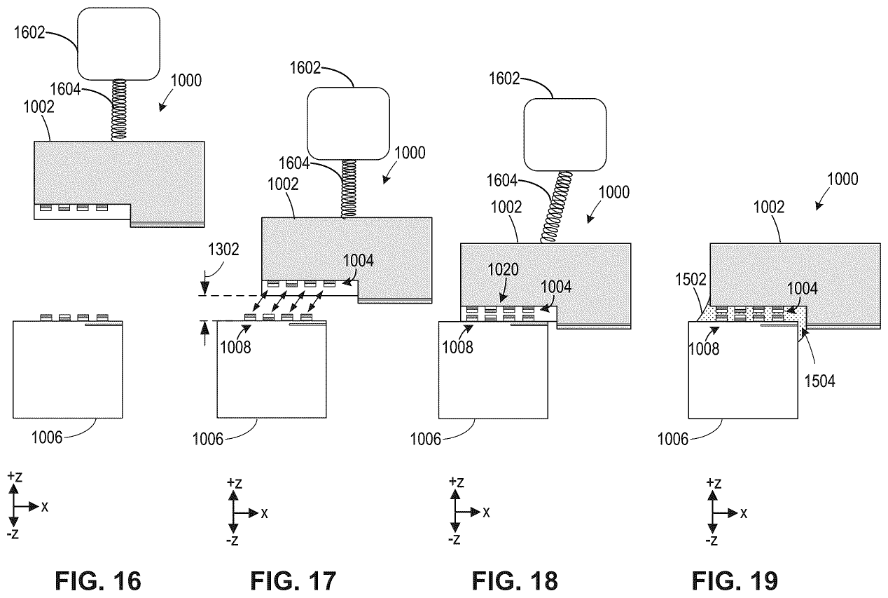

FIGS. 16-19 illustrate various stages of another example method to manufacture an example IC assembly 100, 200, 400, 500, 700, 800, 900, 1000, 1100 disclosed herein. For purposes of explanation, the various stages of FIGS. 16-19 will be described primarily with reference to the IC assembly 1000 of FIGS. 10A and 10B. However, the following discussion applies similar to any other IC assemblies structured in accordance with teachings disclosed herein.

FIG. 16 illustrates an example bonding head 1602 (e.g., a pick-and-place head) coupled to an example first component (e.g., the first component 1002 of FIGS. 10A and 10B). In this example, the bonding head 1602 includes a spring 1604. While one spring 1604 is illustrated in FIG. 16, the bonding head 1602 can include a spring array. In other examples, the bonding head 1602 can include an air bearing.

The bonding head 1602 is used to pick up the first component 1002 and move the first component 1002 towards an example second component (e.g., the second component 1006 of FIGS. 10A and 10B). In particular, as illustrated in FIG. 16, the spring 1604 is detachably coupled to the first component 1002. The spring 1604 can be coupled to the first component 1002 in any manner that is detachable and enable movement of the first component 1002, such as a temporary glue that can be removed, a hook, etc.

FIG. 17 illustrates the assembly 1000 after the bonding head 1602 has begun to move the first component 1002 towards the second component 1006. The bonding head 1602 can move the first component 1002 in one or more directions. For example, the bonding head 1602 head may move the first component 1002 in the x-direction, the y-direction, and/or the z-direction.

In some instances, the initial movement of the first component 1002 in the x- and y-directions is based on fiducials (e.g., the fiducials 1128-1134 of FIG. 11) positioned on the components 1002, 1006. As illustrated in FIG. 18, the spring 1604 allows the first component 1002 to move laterally relative to the second component 1006. For example, if the magnets in the magnet array 1004 have a pitch of 10 μm, the bonding head 1602 can move the first component 1002 to within +/−10 μm of a target alignment in the x- and y-directions, and the spring 1604 can allow the first component 1002 to adjust laterally to the target position during the assembly/alignment process. In some examples, the pitch or spacing of the magnets can be more or less than 10 μm (e.g., 5 μm, 15 μm, 50 μm, 125 μm, etc.). As illustrated in FIG. 18, in some examples, the spring 1604 can tilt due to by the magnetic forces between the magnet arrays 1004, 1008.

In some examples, the bonding head 1602 moves the first component 1002 towards the second component 1006 (e.g., in the negative z-direction). For example, the bonding head 1602 may move the first component 1002 in the negative z direction until the first component 1002 is a distance 1302 from the second component 1006 in the z-direction. For example, the distance 1302 can be a distance such that the first component 1002 will attract towards the second component 1006. In some examples, the distance 1302 is approximately between 2 μm and 5 μm. However, the distance 1302 can be different in other examples. For example, the distance 1302 can be dependent on sizes of the magnets in the magnet array(s) 1004, 1008, sizes of the magnet arrays 1004, 1008, sizes of the components 1002, 1006, etc. When the first component 1002 is the distance 1302 relative the second component 1006, the spring 1604 will deflect and/or stretch to allow the magnet arrays 1004, 1008 to be attracted towards one another to place the first and second components 1002, 1006 into alignment (illustrated in FIG. 18).

Once the components 1002, 1006 have self-aligned, the spring 1604 releases the first component 1002 to allow bonding head 1602 (and the spring 1604) to be disengaged and removed from the first component 1002. Upon release of the first component 1002, the bonding head 1602 and the spring 1604 may be moved in the +z direction. As illustrated in FIG. 18, the first component 1002 self-aligns with the second component 1006 is the x-direction and the y-direction via the magnet arrays 1004, 1008, and in the z-direction via the trench 1020 and the references planes discussed in connection to FIGS. 10A and 10B.

FIG. 19 illustrates the assembly 1000 after deposition of an example optical epoxy material 1502. The optical epoxy material 1502 can be dispensed and cured. In doing so, the first component 1002 can be permanently attached to the second component 1006. Due to the epoxy material 1502, even if the magnetic force degrades over time (e.g., through thermal cycles or environmental changes), such changes will have little to no impact on the attachment between the component 1002, 1006. In other words, in some examples, the magnetic force between the magnet arrays 1004, 1008 is used for the initial alignment, and the epoxy material 1502 provides long-term bonding force.

In some examples, the epoxy material 1502 is dispensed to fill a gap 1504 between the waveguides 1022, 1024 to reduce insertion loss. In some examples, the optical epoxy material 1502 is omitted. In some such examples, the first component 1002 is removably coupled to the second component 1006.

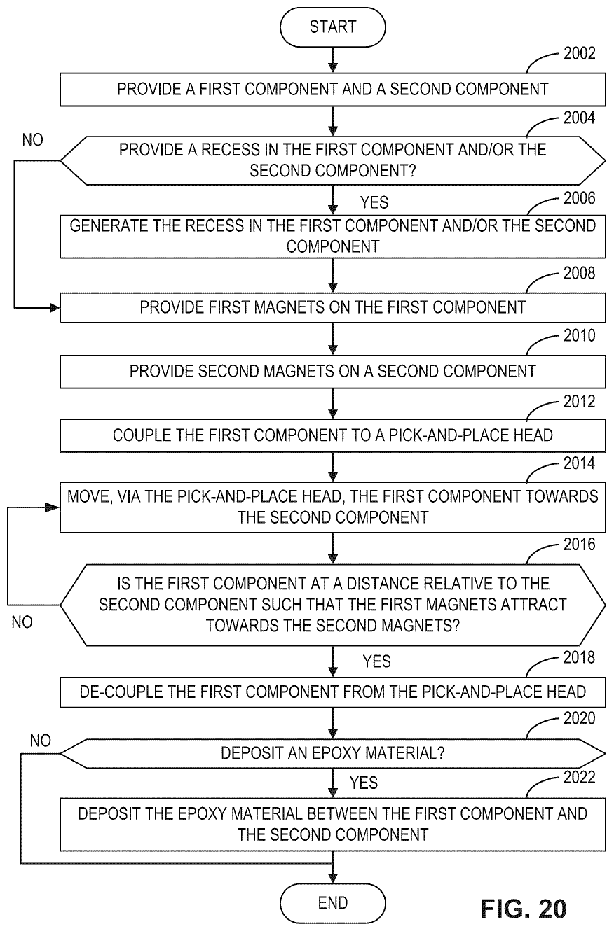

FIG. 20 is a flowchart representative of an example method of fabricating an example IC assembly disclosed herein. In particular, FIG. 20 is a flowchart representative of an example method of fabricating the IC assembly(ies) 100, 200, 400, 500, 700, 800, 900, 1000, 1100 of FIGS. 1, 2A-2B, 3, 4A-4B, 5A-5B, 6, 7A-7B, 8A-8B, 9A-9B, 10A-10B, 11 and/or 12 as represented by the example stages of manufacture shown in FIGS. 12-15 and/or 16-19. For purposes of explanation, the example process of FIG. 20 will be described primarily with reference to the IC assembly 1000 of FIGS. 10A and 10B. However, the following discussion applies similar to any other IC assemblies disclosed herein.

At block 2002, the method includes providing a first component (e.g., the first component 1002 of FIGS. 10A and 10B) and a second component (e.g., the second component 1006 of FIGS. 10A and 10B). For example, the first component 1002 can be a coupler (e.g., the coupler component 122 of FIG. 1) and the second component 1006 can be a PIC (e.g., the PIC 102 of FIG. 1).

At block 2004, the method includes determining whether to provide a trench (e.g., the trench 1020 of FIGS. 10A and 10B) in the first component 1002 and/or the second component 1006. For example, the trench 1020 can be used to facilitate z-directional alignment of the first component 1002 relative to the second component 1006. When the answer to block 2006 is NO, the method proceeds to block 2008.

When the answer to block 2004 is YES, the method includes generating the trench 1020 in the first component 1002 and/or the second component 1006. For example, the trench 1020 is generated in the first component 1002 in the illustrated example of FIGS. 10A and 10B as well as the first component 802 in the illustrated example of FIGS. 8A and 8B. However, the trench can be formed in the first component and/or the second component. For example, in the illustrated example of FIGS. 9A and 9B, both the first component 902 and the second component 904 include a respective trench 906, 912. The method then proceeds to block 2008.

At block 2008, the method includes providing first magnets 406A-406D on the first component 1002. At block 2010, the method includes providing second magnets 406E-406H on the second component 1006. In some examples, the magnets are nanomagnets. In some examples, the providing of the magnets 406 can include a combination of bottom-up 3D nano-printing and top-down film deposition. For example, a non-magnetic 3D scaffold can be nano-printed using Focused Electron Beam Induced Deposition. Subsequently a relatively thin film magnetic material can be thermally evaporated onto the scaffold, leading to a functional 3D magnetic nanostructure.

At block 2012, the method includes coupling the first component 1002 to a pick-and-place head (e.g., the vacuum head 1202 of FIGS. 12-15, the bonding head 1602 of FIGS. 16-19, etc.). For example, the pick-and-place head 1202, 1602 can connect with the first component 1002 in a manner that enables the pick-and-place head 1202, 1602 to move the first component 1002 in one or more directions (e.g., an x-direction, a y-direction, and/or a z-direction).

At block 2014, the method includes moving, via the pick-and-place head 1202, 1602, the first component 1002 towards the second component 1006. In particular, the pick-and-place head 1202, 1602 moves the first component 1002 laterally (e.g., relative to the x-y plane) within a certain distance of the second component 1006. For example, the distance can be based on a pitch of the magnet arrays 402, 404. In some examples, the lateral movement of the first component 1002 is based on fiducials disposed on the components 1002, 1006.

At block 2016, the method includes determining whether the first component 1002 is at a distance (e.g., the distance 1302 of FIGS. 13 and 17) relative to the second component 1006 such that the first magnets 406A-406D attract towards the second magnets 406E-406H. In particular, the distance 1302 may be a z-directional distance between the first component 1002 and the second component 1006. When the answer to block 2016 is NO, the method returns to block 2014 to continue moving the first component 1002 towards the second component 1006. In particular, the method of FIG. 20 includes iterating through blocks 2014 and 2016 until the answer to block 2016 is YES. When the answer to block 2016 is YES, the method advances to block 2018.

At block 2018, the method includes de-coupling the first component 1002 from the pick-and-place head 1202, 1602. For example, when the pick-and-place head 1202, 1602 is a vacuum head 1202, the vacuum head 1202 can release the first component 1002. When the pick-and-place head 1202, 1602 is a bonding head 1602, a corresponding spring 1604 can disengage with the first component 1002 to release the first component 1002. Upon release of the first component 1002, in the case of the vacuum head 1202, the first component 1002 self-aligns with the second component 1006 via magnetic and gravitational forces. In the case of the bonding head 1602, the first component 1002 may self-align with the second component 1006 via magnetic and gravitational forces prior to disengagement of the spring 1604. In some examples, the first component 1002 aligns with the second component 1006 in the x-direction and the y-direction via magnetic forces of the magnet arrays 1004, 1008. Further, gravitational forces cause the first component 1002 to move in a z-direction (e.g., a-z-direction).

Alignment of the first component 1002 relative to the second component 1006 in the z-direction can be achieved using references planes (e.g., a second surface 1012 of the first component 1002 and a third surface 1016 of the second component 1006). When the first and second components 1002, 1006 are coupled, the second surface 1012 of the first component 1002 abuts the third surface 1016 of the second component 1006. A trench 1020 within the first component 1002 is manufactured to accommodate the heights 1014, 1018 of the magnet arrays 1004, 1008 to facilitate the z-directional alignment.

At block 2020, the method includes determining whether to deposit an epoxy material (e.g., the epoxy material 1502 of FIGS. 15 and 19). In some examples, the epoxy material 1502 is dispensed and cured to provide long-term bonding force, even after potential degradation of magnetic forces between the magnet arrays 1004, 1008. In some examples, the epoxy material 1502 is omitted such that the first component 1002 is detachably coupled to the second component 1006. When the answer to block 2022 is YES, the method proceeds to block 2022 at which the epoxy material 1502 is deposited between the first component 1002 and the second component 1006. When the answer to block 2022 is NO, the method is complete.

Although the example operations 2000 are described with reference to the flowchart illustrated in FIG. 20, many other methods of assembling an interconnect implemented in accordance with the teachings of this disclosure may alternatively be used. For example, the order of execution of the blocks may be changed, and/or some of the blocks described may be changed, eliminated, or combined.

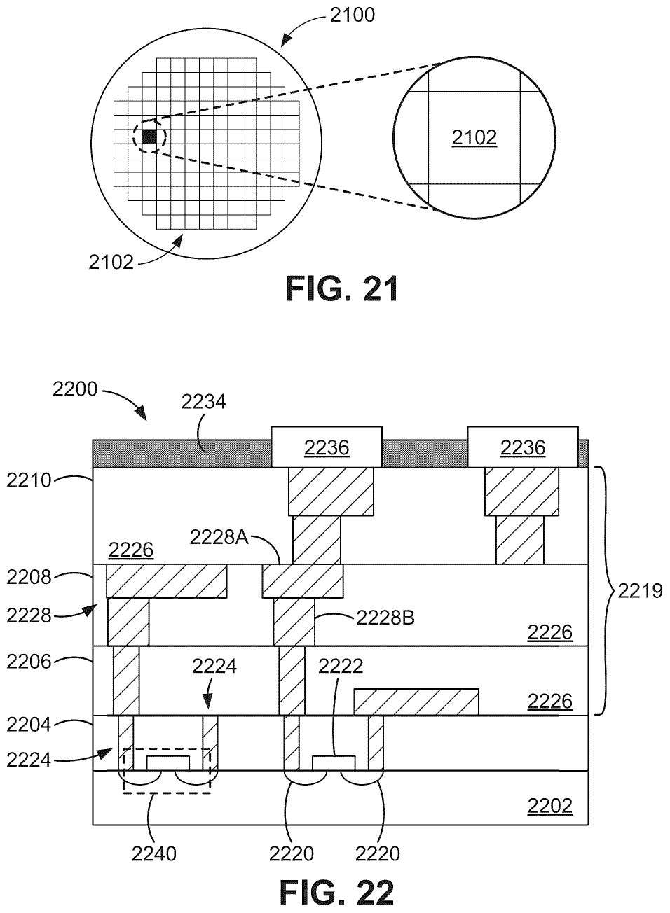

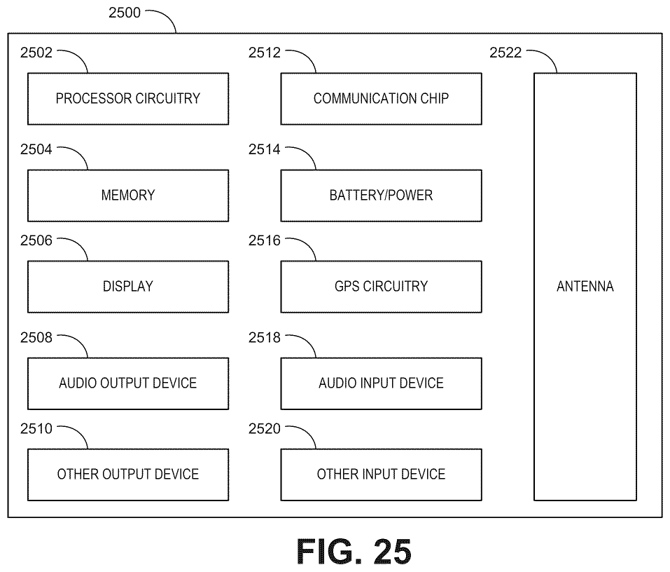

FIG. 21 is a top view of a wafer 2100 and dies 2102 that may be included in an IC package that includes one or more example assemblies 100, 200, 400, 500, 700, 800, 900, 1000, 1100 in accordance with any of the examples disclosed herein. The wafer 2100 includes semiconductor material and one or more dies 2102 having circuitry. Each of the dies 2102 may be a repeating unit of a semiconductor product. After the fabrication of the semiconductor product is complete, the wafer 2100 may undergo a singulation process in which the dies 2102 are separated from one another to provide discrete “chips.” The die 2102 includes one or more transistors (e.g., some of the transistors 2240 of FIG. 22, discussed below), supporting circuitry to route electrical signals to the transistors, passive components (e.g., traces, resistors, capacitors, inductors, and/or other circuitry), and/or any other components. In some examples, the die 2102 may include and/or implement a memory device (e.g., a random access memory (RAM) device, such as a static RAM (SRAM) device, a magnetic RAM (MRAM) device, a resistive RAM (RRAM) device, a conductive-bridging RAM (CBRAM) device, etc.), a logic device (e.g., an AND, OR, NAND, or NOR gate), or any other suitable circuitry or electronics. Multiple ones of these devices may be combined on a single die 2102. For example, a memory array of multiple memory circuits may be formed on a same die 2102 as programmable circuitry (e.g., the processor circuitry 2502 of FIG. 25) and/or other logic circuitry. Such memory may store information for use by the programmable circuitry.

FIG. 22 is a cross-sectional side view of an IC device 2200 that may be included in an IC package that includes one or more example assemblies 100, 200, 400, 500, 700, 800, 900, 1000, 1100 in accordance with any of the examples disclosed herein. One or more of the IC devices 2200 may be included in one or more dies 2102 (FIG. 21). The IC device 2200 may be formed on a die substrate 2202 (e.g., the wafer 2100 of FIG. 21) and may be included in a die (e.g., the die 2102 of FIG. 21). The die substrate 2202 may be a semiconductor substrate including semiconductor materials including, for example, n-type or p-type materials systems (or a combination of both). The die substrate 2202 may include, for example, a crystalline substrate formed using a bulk silicon or a silicon-on-insulator (SOI) substructure. In some examples, the die substrate 2202 may be formed using alternative materials, which may or may not be combined with silicon, that include but are not limited to germanium, indium antimonide, lead telluride, indium arsenide, indium phosphide, gallium arsenide, or gallium antimonide. Further materials classified as group II-VI, III-V, or IV may also be used to form the die substrate 2202. Although a few examples of materials from which the die substrate 2202 may be formed are described here, any material that may serve as a foundation for an IC device 2200 may be used. The die substrate 2202 may be part of a singulated die (e.g., the dies 2102 of FIG. 21) or a wafer (e.g., the wafer 2100 of FIG. 21).

The IC device 2200 may include one or more device layers 2204 disposed on and/or above the die substrate 2202. The device layer 2204 may include features of one or more transistors 2240 (e.g., metal oxide semiconductor field-effect transistors (MOSFETs)) formed on the die substrate 2202. The device layer 2204 may include, for example, one or more source and/or drain (S/D) regions 2220, a gate 2222 to control current flow between the S/D regions 2220, and one or more S/D contacts 2224 to route electrical signals to/from the S/D regions 2220. The transistors 2240 may include additional features not depicted for the sake of clarity, such as device isolation regions, gate contacts, and the like. The transistors 2240 are not limited to the type and configuration depicted in FIG. 22 and may include a wide variety of other types and/or configurations such as, for example, planar transistors, non-planar transistors, or a combination of both. Non-planar transistors may include FinFET transistors, such as double-gate transistors or tri-gate transistors, and wrap-around or all-around gate transistors, such as nanoribbon and nanowire transistors.

Each transistor 2240 may include a gate 2222 including a gate dielectric and a gate electrode. The gate dielectric may include one layer or a stack of layers. The one or more layers may include silicon oxide, silicon dioxide, silicon carbide, and/or a high-k dielectric material. The high-k dielectric material may include elements such as hafnium, silicon, oxygen, titanium, tantalum, lanthanum, aluminum, zirconium, barium, strontium, yttrium, lead, scandium, niobium, and/or zinc. Examples of high-k materials that may be used in the gate dielectric include, but are not limited to, hafnium oxide, hafnium silicon oxide, lanthanum oxide, lanthanum aluminum oxide, zirconium oxide, zirconium silicon oxide, tantalum oxide, titanium oxide, barium strontium titanium oxide, barium titanium oxide, strontium titanium oxide, yttrium oxide, aluminum oxide, lead scandium tantalum oxide, and/or lead zinc niobate. In some examples, an annealing process may be carried out on the gate dielectric to improve its quality when a high-k material is used.

The gate electrode may be formed on the gate dielectric and may include at least one p-type work function metal or n-type work function metal, depending on whether the transistor 2240 is to be a p-type metal oxide semiconductor (PMOS) or an n-type metal oxide semiconductor (NMOS) transistor. In some implementations, the gate electrode may include a stack of two or more metal layers, where one or more metal layers are work function metal layers and at least one metal layer is a fill metal layer. Further metal layers may be included, such as a barrier layer. For a PMOS transistor, metals that may be used for the gate electrode include, but are not limited to, ruthenium, palladium, platinum, cobalt, nickel, conductive metal oxides (e.g., ruthenium oxide), and/or any of the metals discussed below with reference to an NMOS transistor (e.g., for work function tuning). For an NMOS transistor, metals that may be used for the gate electrode include, but are not limited to, hafnium, zirconium, titanium, tantalum, aluminum, alloys of these metals, carbides of these metals (e.g., hafnium carbide, zirconium carbide, titanium carbide, tantalum carbide, and/or aluminum carbide), and/or any of the metals discussed above with reference to a PMOS transistor (e.g., for work function tuning).

In some examples, when viewed as a cross-section of the transistor 2240 along the source-channel-drain direction, the gate electrode may include a U-shaped structure that includes a bottom portion substantially parallel to the surface of the die substrate 2202 and two sidewall portions that are substantially perpendicular to the top surface of the die substrate 2202. In other examples, at least one of the metal layers that form the gate electrode may be a planar layer that is substantially parallel to the top surface of the die substrate 2202 and does not include sidewall portions substantially perpendicular to the top surface of the die substrate 2202. In other examples, the gate electrode may include a combination of U-shaped structures and/or planar, non-U-shaped structures. For example, the gate electrode may include one or more U-shaped metal layers formed atop one or more planar, non-U-shaped layers.

In some examples, a pair of sidewall spacers may be formed on opposing sides of the gate stack to bracket the gate stack. The sidewall spacers may be formed from materials such as silicon nitride, silicon oxide, silicon carbide, silicon nitride doped with carbon, and/or silicon oxynitride. Processes for forming sidewall spacers are well known in the art and generally include deposition and etching process operations. In some examples, a plurality of spacer pairs may be used; for instance, two pairs, three pairs, or four pairs of sidewall spacers may be formed on opposing sides of the gate stack.

The S/D regions 2220 may be formed within the die substrate 2202 adjacent to the gate 2222 of corresponding transistor(s) 2240. The S/D regions 2220 may be formed using an implantation/diffusion process or an etching/deposition process, for example. In the former process, dopants such as boron, aluminum, antimony, phosphorous, or arsenic may be ion-implanted into the die substrate 2202 to form the S/D regions 2220. An annealing process that activates the dopants and causes them to diffuse farther into the die substrate 2202 may follow the ion-implantation process. In the latter process, the die substrate 2202 may first be etched to form recesses at the locations of the S/D regions 2220. An epitaxial deposition process may then be carried out to fill the recesses with material that is used to fabricate the S/D regions 2220. In some implementations, the S/D regions 2220 may be fabricated using a silicon alloy such as silicon germanium or silicon carbide. In some examples, the epitaxially deposited silicon alloy may be doped in situ with dopants such as boron, arsenic, or phosphorous. In some examples, the S/D regions 2220 may be formed using one or more alternate semiconductor materials such as germanium or a group III-V material or alloy. In further examples, one or more layers of metal and/or metal alloys may be used to form the S/D regions 2220.

Electrical signals, such as power and/or input/output (I/O) signals, may be routed to and/or from the devices (e.g., transistors 2240) of the device layer 2204 through one or more interconnect layers disposed on the device layer 2204 (illustrated in FIG. 22 as interconnect layers 2206-2210). For example, electrically conductive features of the device layer 2204 (e.g., the gate 2222 and the S/D contacts 2224) may be electrically coupled with the interconnect structures 2228 of the interconnect layers 2206-2210. The one or more interconnect layers 2206-2210 may form a metallization stack (also referred to as an “ILD stack”) 2219 of the IC device 2200.

The interconnect structures 2228 may be arranged within the interconnect layers 2206-2210 to route electrical signals according to a wide variety of designs (in particular, the arrangement is not limited to the particular configuration of interconnect structures 2228 depicted in FIG. 22). Although a particular number of interconnect layers 2206-2210 is depicted in FIG. 22, examples of the present disclosure include IC devices having more or fewer interconnect layers than depicted.

In some examples, the interconnect structures 2228 may include lines 2228a and/or vias 2228b filled with an electrically conductive material such as a metal. The lines 2228a may be arranged to route electrical signals in a direction of a plane that is substantially parallel with a surface of the die substrate 2202 upon which the device layer 2204 is formed. For example, the lines 2228a may route electrical signals in a direction in and/or out of the page from the perspective of FIG. 22. The vias 2228b may be arranged to route electrical signals in a direction of a plane that is substantially perpendicular to the surface of the die substrate 2202 upon which the device layer 2204 is formed. In some examples, the vias 2228b may electrically couple lines 2228a of different interconnect layers 2206-2210 together.

The interconnect layers 2206-2210 may include a dielectric material 2226 disposed between the interconnect structures 2228, as shown in FIG. 22. In some examples, the dielectric material 2226 disposed between the interconnect structures 2228 in different ones of the interconnect layers 2206-2210 may have different compositions; in other examples, the composition of the dielectric material 2226 between different interconnect layers 2206-2210 may be the same.

A first interconnect layer 2206 (referred to as Metal 1 or “M1”) may be formed directly on the device layer 2204. In some examples, the first interconnect layer 2206 may include lines 2228a and/or vias 2228b, as shown. The lines 2228a of the first interconnect layer 2206 may be coupled with contacts (e.g., the S/D contacts 2224) of the device layer 2204.

A second interconnect layer 2208 (referred to as Metal 2 or “M2”) may be formed directly on the first interconnect layer 2206. In some examples, the second interconnect layer 2208 may include vias 2228b to couple the lines 2228a of the second interconnect layer 2208 with the lines 2228a of the first interconnect layer 2206. Although the lines 2228a and the vias 2228b are structurally delineated with a line within each interconnect layer (e.g., within the second interconnect layer 2208) for the sake of clarity, the lines 2228a and the vias 2228b may be structurally and/or materially contiguous (e.g., simultaneously filled during a dual-damascene process) in some examples.

A third interconnect layer 2210 (referred to as Metal 3 or “M3”) (and additional interconnect layers, as desired) may be formed in succession on the second interconnect layer 2208 according to similar techniques and/or configurations described in connection with the second interconnect layer 2208 or the first interconnect layer 2206. In some examples, the interconnect layers that are “higher up” in the metallization stack 2219 in the IC device 2200 (i.e., further away from the device layer 2204) may be thicker.

The IC device 2200 may include a solder resist material 2234 (e.g., polyimide or similar material) and one or more conductive contacts 2236 formed on the interconnect layers 2206-2210. In FIG. 22, the conductive contacts 2236 are illustrated as taking the form of bond pads. The conductive contacts 2236 may be electrically coupled with the interconnect structures 2228 and configured to route the electrical signals of the transistor(s) 2240 to other external devices. For example, solder bonds may be formed on the one or more conductive contacts 2236 to mechanically and/or electrically couple a chip including the IC device 2200 with another component (e.g., a circuit board). The IC device 2200 may include additional or alternate structures to route the electrical signals from the interconnect layers 2206-2210; for example, the conductive contacts 2236 may include other analogous features (e.g., posts) that route the electrical signals to external components.

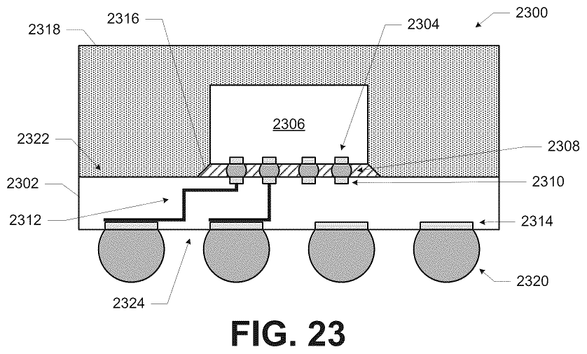

FIG. 23 is a cross-sectional view of an example IC package 2300. In some examples, the example IC package 2300 includes and/or corresponds to one or more example assemblies 100, 200, 400, 500, 700, 800, 900, 1000, 1100 disclosed herein. The package substrate 2302 may include a dielectric material, and may have conductive pathways extending through the dielectric material between upper and lower faces 2322, 2324, and/or between different locations on the upper face 2322, and/or between different locations on the lower face 2324. These conductive pathways may take the form of any of the interconnects 2228 discussed above with reference to FIG. 22.

The IC package 2300 may include a die 2306 coupled to the package substrate 2302 via conductive contacts 2304 of the die 2306, first-level interconnects 2308, and conductive contacts 2310 of the package substrate 2302. The conductive contacts 2310 may be coupled to conductive pathways 2312 through the package substrate 2302, allowing circuitry within the die 2306 to electrically couple to various ones of the conductive contacts 2314 (or to other devices included in the package substrate 2302, not shown). The first-level interconnects 2308 illustrated in FIG. 23 are solder bumps, but any suitable first-level interconnects 2308 may be used. As used herein, a “conductive contact” refers to a portion of conductive material (e.g., metal) serving as an electrical interface between different components. Conductive contacts may be recessed in, flush with, or extending away from a surface of a component, and may take any suitable form (e.g., a conductive pad or socket).

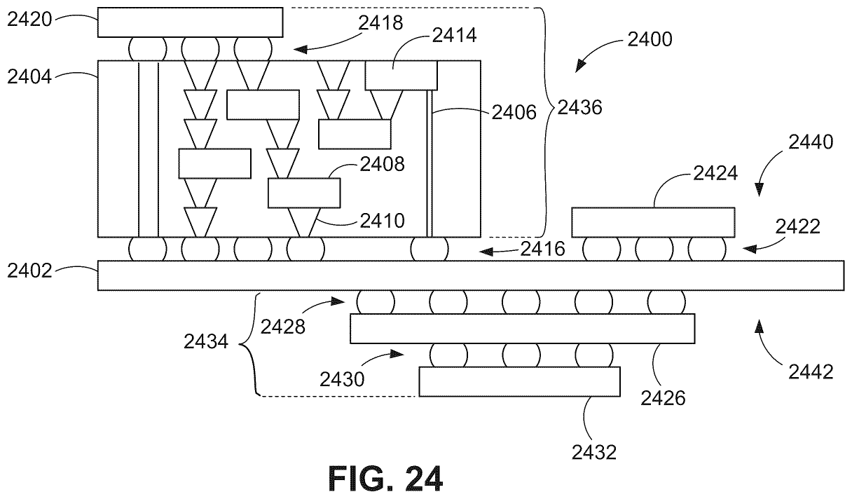

In some examples, an underfill material 2316 may be disposed between the die 2306 and the package substrate 2302 around the first-level interconnects 2308, and/or a mold compound 2318 may be disposed around the die 2306 and in contact with the package substrate 2302. In some examples, the underfill material 2316 may be the same as the mold compound 2318. Example materials that may be used for the underfill material 2316 and the mold compound 2318 are epoxy mold materials, as suitable. Second-level interconnects 2320 may be coupled to the conductive contacts 2314. The second-level interconnects 2320 illustrated in FIG. 23 are solder balls (e.g., for a ball grid array arrangement), but any suitable second-level interconnects 2320 may be used (e.g., pins in a pin grid array arrangement or lands in a land grid array arrangement). The second-level interconnects 2320 may be used to couple the IC package 2300 to another component, such as a circuit board (e.g., a motherboard), an interposer, or another IC package, as known in the art and as discussed below with reference to FIG. 24.

The die 2306 may take the form of any of the examples of the die 2502 discussed herein (e.g., may include any of the examples of the IC device 2200).

Although the IC package 2300 illustrated in FIG. 23 is a flip chip package, other package architectures may be used. For example, the IC package 2300 may be a ball grid array (BGA) package, such as an embedded wafer-level ball grid array (eWLB) package. In another example, the IC package 2300 may be a wafer-level chip scale package (WLCSP) or a panel fanout (FO) package. Although a single die 2306 is illustrated in the IC package 2300 of FIG. 23, an IC package 2300 may include multiple dies 2306. An IC package 2300 may include additional passive components, such as surface-mount resistors, capacitors, and/or inductors disposed on the first face 2322 or the second face 2324 of the package substrate 2302. More generally, an IC package 2300 may include any other active and/or passive components known in the art.

FIG. 24 is a cross-sectional side view of an IC device assembly 2400. In some examples, the IC device assembly corresponds to the one or more example assemblies 100, 200, 400, 500, 700, 800, 900, 1000, 1100 disclosed herein. The IC device assembly 2400 includes a number of components disposed on a circuit board 2402 (which may be, for example, a motherboard). The IC device assembly 2400 includes components disposed on a first face 2440 of the circuit board 2402 and an opposing second face 2442 of the circuit board 2402; generally, components may be disposed on one or both faces 2440 and 2442.

In some examples, the circuit board 2402 may be a printed circuit board (PCB) including multiple metal layers separated from one another by layers of dielectric material and interconnected by electrically conductive vias. Any one or more of the metal layers may be formed in a desired circuit pattern to route electrical signals (optionally in conjunction with other metal layers) between the components coupled to the circuit board 2402. In other examples, the circuit board 2402 may be a non-PCB substrate.

The IC device assembly 2400 illustrated in FIG. 24 includes a package-on-interposer structure 2436 coupled to the first face 2440 of the circuit board 2402 by coupling components 2416. The coupling components 2416 may electrically and mechanically couple the package-on-interposer structure 2436 to the circuit board 2402, and may include solder balls (as shown in FIG. 24), male and female portions of a socket, an adhesive, an underfill material, and/or any other suitable electrical and/or mechanical coupling structure.

The package-on-interposer structure 2436 may include an IC package 2420 coupled to an interposer 2404 by coupling components 2418. The coupling components 2418 may take any suitable form for the application, such as the forms discussed above with reference to the coupling components 2416. Although a single IC package 2420 is shown in FIG. 24, multiple IC packages may be coupled to the interposer 2404; indeed, additional interposers may be coupled to the interposer 2404. The interposer 2404 may provide an intervening substrate used to bridge the circuit board 2402 and the IC package 2420. The IC package 2420 may be or include, for example, a die (the die 2102 of FIG. 21), an IC device (e.g., the IC device 2200 of FIG. 22), or any other suitable component. Generally, the interposer 2404 may spread a connection to a wider pitch or reroute a connection to a different connection. For example, the interposer 2404 may couple the IC package 2420 (e.g., a die) to a set of BGA conductive contacts of the coupling components 2416 for coupling to the circuit board 2402. In the example illustrated in FIG. 24, the IC package 2420 and the circuit board 2402 are attached to opposing sides of the interposer 2404; in other examples, the IC package 2420 and the circuit board 2402 may be attached to a same side of the interposer 2404. In some examples, three or more components may be interconnected by way of the interposer 2404.

In some examples, the interposer 2404 may be formed as a PCB, including multiple metal layers separated from one another by layers of dielectric material and interconnected by electrically conductive vias. In some examples, the interposer 2404 may be formed of an epoxy resin, a fiberglass-reinforced epoxy resin, an epoxy resin with inorganic fillers, a ceramic material, or a polymer material such as polyimide. In some examples, the interposer 2404 may be formed of alternate rigid or flexible materials that may include the same materials described above for use in a semiconductor substrate, such as silicon, germanium, and other group III-V and group IV materials. The interposer 2404 may include metal interconnects 2408 and vias 2410, including but not limited to through-silicon vias (TSVs) 2406. The interposer 2404 may further include embedded devices 2414, including both passive and active devices. Such devices may include, but are not limited to, capacitors, decoupling capacitors, resistors, inductors, fuses, diodes, transformers, sensors, electrostatic discharge (ESD) devices, and memory devices. More complex devices such as radio frequency devices, power amplifiers, power management devices, antennas, arrays, sensors, and microelectromechanical systems (MEMS) devices may also be formed on the interposer 2404. The package-on-interposer structure 2436 may take the form of any of the package-on-interposer structures known in the art.

The IC device assembly 2400 may include an IC package 2424 coupled to the first face 2440 of the circuit board 2402 by coupling components 2422. The coupling components 2422 may take the form of any of the examples discussed above with reference to the coupling components 2416, and the IC package 2424 may take the form of any of the examples discussed above with reference to the IC package 2420.

The IC device assembly 2400 illustrated in FIG. 24 includes a package-on-package structure 2434 coupled to the second face 2442 of the circuit board 2402 by coupling components 2428. The package-on-package structure 2434 may include a first IC package 2426 and a second IC package 2432 coupled together by coupling components 2430 such that the first IC package 2426 is disposed between the circuit board 2402 and the second IC package 2432. The coupling components 2428, 2430 may take the form of any of the examples of the coupling components 2416 discussed above, and the IC packages 2426, 2432 may take the form of any of the examples of the IC package 2420 discussed above. The package-on-package structure 2434 may be configured in accordance with any of the package-on-package structures known in the art.

FIG. 25 is a block diagram of an example electrical device 2500 that may include one or more of the example IC assemblies 100, 200, 400, 500, 700, 800, 900, 1000, 1100. For example, any suitable ones of the components of the electrical device 2500 may include one or more of the device assemblies 2400, IC devices 2200, or dies 2102 disclosed herein. A number of components are illustrated in FIG. 25 as included in the electrical device 2500, but any one or more of these components may be omitted or duplicated, as suitable for the application. In some examples, some or all of the components included in the electrical device 2500 may be attached to one or more motherboards. In some examples, some or all of these components are fabricated onto a single system-on-a-chip (SoC) die.

Additionally, in various examples, the electrical device 2500 may not include one or more of the components illustrated in FIG. 25, but the electrical device 2500 may include interface circuitry for coupling to the one or more components. For example, the electrical device 2500 may not include a display 2506, but may include display interface circuitry (e.g., a connector and driver circuitry) to which a display 2506 may be coupled. In another set of examples, the electrical device 2500 may not include an audio input device 2518 (e.g., microphone) or an audio output device 2508 (e.g., a speaker, a headset, earbuds, etc.), but may include audio input or output device interface circuitry (e.g., connectors and supporting circuitry) to which an audio input device 2518 or audio output device 2508 may be coupled.

The electrical device 2500 may include programmable circuitry 2502 (e.g., one or more processing devices). The programmable circuitry 2502 may include one or more digital signal processors (DSPs), application-specific integrated circuits (ASICs), central processing units (CPUs), graphics processing units (GPUs), cryptoprocessors (specialized processors that execute cryptographic algorithms within hardware), server processors, or any other suitable processing devices. The electrical device 2500 may include a memory 2504, which may itself include one or more memory devices such as volatile memory (e.g., dynamic random access memory (DRAM)), nonvolatile memory (e.g., read-only memory (ROM)), flash memory, solid state memory, and/or a hard drive. In some examples, the memory 2504 may include memory that shares a die with the programmable circuitry 2502. This memory may be used as cache memory and may include embedded dynamic random access memory (eDRAM) or spin transfer torque magnetic random access memory (STT-MRAM).

In some examples, the electrical device 2500 may include a communication chip 2512 (e.g., one or more communication chips). For example, the communication chip 2512 may be configured for managing wireless communications for the transfer of data to and from the electrical device 2500. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some examples they might not.

The communication chip 2512 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication chip 2512 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 2512 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 2512 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 2512 may operate in accordance with other wireless protocols in other examples. The electrical device 2500 may include an antenna 2522 to facilitate wireless communications and/or to receive other wireless communications (such as AM or FM radio transmissions).

In some examples, the communication chip 2512 may manage wired communications, such as electrical, optical, or any other suitable communication protocols (e.g., the Ethernet). As noted above, the communication chip 2512 may include multiple communication chips. For instance, a first communication chip 2512 may be dedicated to shorter-range wireless communications such as Wi-Fi or Bluetooth, and a second communication chip 2512 may be dedicated to longer-range wireless communications such as global positioning system (GPS), EDGE, GPRS, CDMA, WiMAX, LTE, EV-DO, or others. In some examples, a first communication chip 2512 may be dedicated to wireless communications, and a second communication chip 2512 may be dedicated to wired communications.

The electrical device 2500 may include battery/power circuitry 2514. The battery/power circuitry 2514 may include one or more energy storage devices (e.g., batteries or capacitors) and/or circuitry for coupling components of the electrical device 2500 to an energy source separate from the electrical device 2500 (e.g., AC line power).

The electrical device 2500 may include a display 2506 (or corresponding interface circuitry, as discussed above). The display 2506 may include any visual indicators, such as a heads-up display, a computer monitor, a projector, a touchscreen display, a liquid crystal display (LCD), a light-emitting diode display, or a flat panel display.

The electrical device 2500 may include an audio output device 2508 (or corresponding interface circuitry, as discussed above). The audio output device 2508 may include any device that generates an audible indicator, such as speakers, headsets, or earbuds.

The electrical device 2500 may include an audio input device 2518 (or corresponding interface circuitry, as discussed above). The audio input device 2518 may include any device that generates a signal representative of a sound, such as microphones, microphone arrays, or digital instruments (e.g., instruments having a musical instrument digital interface (MIDI) output).

The electrical device 2500 may include GPS circuitry 2516. The GPS circuitry 2516 may be in communication with a satellite-based system and may receive a location of the electrical device 2500, as known in the art.

The electrical device 2500 may include any other output device 2510 (or corresponding interface circuitry, as discussed above). Examples of the other output device 2510 may include an audio codec, a video codec, a printer, a wired or wireless transmitter for providing information to other devices, or an additional storage device.

The electrical device 2500 may include any other input device 2520 (or corresponding interface circuitry, as discussed above). Examples of the other input device 2520 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The electrical device 2500 may have any desired form factor, such as a hand-held or mobile electrical device (e.g., a cell phone, a smart phone, a mobile internet device, a music player, a tablet computer, a laptop computer, a netbook computer, an ultrabook computer, a personal digital assistant (PDA), an ultra mobile personal computer, etc.), a desktop electrical device, a server or other networked computing component, a printer, a scanner, a monitor, a set-top box, an entertainment control unit, a vehicle control unit, a digital camera, a digital video recorder, or a wearable electrical device. In some examples, the electrical device 2500 may be any other electronic device that processes data.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

Notwithstanding the foregoing, in the case of referencing a semiconductor device (e.g., a transistor), a semiconductor die containing a semiconductor device, and/or an integrated circuit (IC) package containing a semiconductor die during fabrication or manufacturing, “above” is not with reference to Earth, but instead is with reference to an underlying substrate on which relevant components are fabricated, assembled, mounted, supported, or otherwise provided. Thus, as used herein and unless otherwise stated or implied from the context, a first component within a semiconductor die (e.g., a transistor or other semiconductor device) is “above” a second component within the semiconductor die when the first component is farther away from a substrate (e.g., a semiconductor wafer) during fabrication/manufacturing than the second component on which the two components are fabricated or otherwise provided. Similarly, unless otherwise stated or implied from the context, a first component within an IC package (e.g., a semiconductor die) is “above” a second component within the IC package during fabrication when the first component is farther away from a printed circuit board (PCB) to which the IC package is to be mounted or attached. It is to be understood that semiconductor devices are often used in orientation different than their orientation during fabrication. Thus, when referring to a semiconductor device (e.g., a transistor), a semiconductor die containing a semiconductor device, and/or an integrated circuit (IC) package containing a semiconductor die during use, the definition of “above” in the preceding paragraph (i.e., the term “above” describes the relationship of two parts relative to Earth) will likely govern based on the usage context.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that enable waveguide alignment between optical components. Example disclosed herein provide waveguide alignment in an x-direction and a y-direction using magnet arrays disposed on surfaces of the optical components. Examples disclosed herein provide waveguide alignment in a z-direction using recessed surfaces on which a magnet array(s) may be positioned. For example, by positioning one or more magnet arrays within a trench, the trench can be used to accommodate heights of the magnet array(s) to facilitate z-directional alignment. Further examples and combinations thereof include the following:

Example 1 includes an apparatus comprising a first component having a first surface and a first waveguide, the first component having a first magnet array on the first surface, and a second component having a second surface and a second waveguide, the second component having a second magnet array on the second surface, the first magnet array to be attracted towards the second magnet array to urge the first magnet array into alignment with the second magnet array, the first waveguide positioned to at least one of transmit or receive an optical signal to or from the second waveguide when the first magnet array is in alignment with the second magnet array.

Example 2 includes the apparatus of example 1, wherein the first component includes a third surface, the first surface being recessed relative to the third surface.

Example 3 includes the apparatus of example 2, wherein the second component includes a fourth surface, the second surface being recessed relative to the fourth surface.

Example 4 includes the apparatus of example 3, wherein the third surface of the first component abuts the fourth surface of the second component such that a gap is maintained between the first magnet array and the second magnet array.

Example 5 includes the apparatus of any one of examples 1-4, wherein the first and second magnet arrays include magnets having polarities such that the first and second magnet arrays are attracted toward a first arrangement relative to one another more than the first and second magnet arrays are attracted to a second arrangement relative to one another.

Example 6 includes the apparatus of any one of examples 1-5, wherein the alignment of the first magnet array and the second magnet array causes alignment of the first waveguide relative to the second waveguide in an X-direction and a Y-direction, both the X-direction and the Y-direction extending substantially parallel to the first surface.

Example 7 includes the apparatus of any one of examples 1-6, wherein the first component is a photonic integrated circuit, and the second component is an optical coupler.

Example 8 includes the apparatus of any one of examples 1-7, further including an optical epoxy positioned between the first surface of the first component and the second surface of the second component to couple the first component and the second component, the optical epoxy to be between adjacent magnets in the first magnet array.

Example 9 includes the apparatus of any one of examples 1-8, wherein the first component is removably couplable relative to the second component.

Example 10 includes a semiconductor assembly comprising a semiconductor component having a first waveguide and first magnets on a first surface of the semiconductor component, and a coupler component having a second waveguide and second magnets on a second surface of the semiconductor component, the first surface facing the second surface, north poles of ones of the first magnets aligned with and adjacent south poles of corresponding ones of the second magnets, the first waveguide optically aligned with the second waveguide in a first direction and a second direction perpendicular to the first direction.

Example 11 includes the semiconductor assembly of example 10, wherein the first direction and the second direction are both in a plane substantially parallel to the first surface.

Example 12 includes the semiconductor assembly of any one of examples 10-11, wherein the first magnets are spaced apart from the first waveguide by a first distance, the first distance to reduce an impact of insertion loss.

Example 13 includes the semiconductor assembly of any one of examples 10-12, wherein the coupler component includes a third surface, the second surface recessed relative to the third surface.

Example 14 includes the semiconductor assembly of any one of examples 10-13, wherein the semiconductor component includes a first fiducial on the first surface adjacent the first magnets, and the coupler component includes a second fiducial on the second surface adjacent the second magnets.

Example 15 includes a method comprising providing a first array of magnets on a first component, the first component including a first waveguide, providing a second array of magnets on a second component, the second component including a second waveguide, and moving the first component towards the second component such that the second array of magnets attract the first array of magnets, a magnetic force between the first and second array of magnets to urge the first component into a spatial relationship with the second component in which the first waveguide is optically aligned with the second waveguide.

Example 16 includes the method of example 15, further including coupling the first component to a pick-and-place head, and when the first array of magnets attracts the second array of magnets, de-coupling the first component from the pick-and-place head.

Example 17 includes the method of example 16, wherein the first component is coupled to the pick-and-place head via at least one of a spring or an air bearing, the at least one of the spring or the air bearing to enable the first component to move relative to the pick-and-place head in response to the magnetic force between the first and second array of magnets.

Example 18 includes the method of example 16, wherein the first component is coupled to the pick-and-place head via a vacuum head, the vacuum head to release the first component to de-couple the first component from the pick-and-place head.

Example 19 includes the method of example 18, wherein the moving of the first component towards the second component includes moving the first component within a distance of the second component, the distance less than or equal to half a pitch the first array of magnets.

Example 20 includes the method of example 16, further including dispensing an optical epoxy between the first component and the second component.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
a first component having a first surface and a first waveguide, the first component having a first magnet array on the first surface; and
a second component having a second surface and a second waveguide, the second component having a second magnet array on the second surface, the first magnet array to be attracted towards the second magnet array to urge the first magnet array into alignment with the second magnet array, the first waveguide positioned to at least one of transmit or receive an optical signal to or from the second waveguide when the first magnet array is in alignment with the second magnet array.

2. The apparatus of claim 1, wherein the first component includes a third surface, the first surface being recessed relative to the third surface.

3. The apparatus of claim 2, wherein the second component includes a fourth surface, the second surface being recessed relative to the fourth surface.

4. The apparatus of claim 3, wherein the third surface of the first component abuts the fourth surface of the second component such that a gap is maintained between the first magnet array and the second magnet array.

5. The apparatus of claim 1, wherein the first and second magnet arrays include magnets having polarities such that the first and second magnet arrays are attracted toward a first arrangement relative to one another more than the first and second magnet arrays are attracted to a second arrangement relative to one another.

6. The apparatus of claim 1, wherein the alignment of the first magnet array and the second magnet array causes alignment of the first waveguide relative to the second waveguide in an X-direction and a Y-direction, both the X-direction and the Y-direction extending substantially parallel to the first surface.

7. The apparatus of claim 1, wherein the first component is a photonic integrated circuit, and the second component is an optical coupler.

8. The apparatus of claim 1, further including an optical epoxy positioned between the first surface of the first component and the second surface of the second component to couple the first component and the second component, the optical epoxy to be between adjacent magnets in the first magnet array.

9. The apparatus of claim 1, wherein the first component is removably couplable relative to the second component.

10. A semiconductor assembly comprising:
a semiconductor component having a first waveguide and first magnets on a first surface of the semiconductor component; and
a coupler component having a second waveguide and second magnets on a second surface of the semiconductor component, the first surface facing the second surface, north poles of ones of the first magnets aligned with and adjacent south poles of corresponding ones of the second magnets, the first waveguide optically aligned with the second waveguide in a first direction and a second direction perpendicular to the first direction.

11. The semiconductor assembly of claim 10, wherein the first direction and the second direction are both in a plane substantially parallel to the first surface.

12. The semiconductor assembly of claim 10, wherein the first magnets are spaced apart from the first waveguide by a first distance, the first distance to reduce an impact of insertion loss.

13. The semiconductor assembly of claim 10, wherein the coupler component includes a third surface, the second surface recessed relative to the third surface.

14. The semiconductor assembly of claim 10, wherein the semiconductor component includes a first fiducial on the first surface adjacent the first magnets, and the coupler component includes a second fiducial on the second surface adjacent the second magnets.

15. A method comprising:
providing a first array of magnets on a first component, the first component including a first waveguide;
providing a second array of magnets on a second component, the second component including a second waveguide; and
moving the first component towards the second component such that the second array of magnets attract the first array of magnets, a magnetic force between the first and second array of magnets to urge the first component into a spatial relationship with the second component in which the first waveguide is optically aligned with the second waveguide.

16. The method of claim 15, further including:
coupling the first component to a pick-and-place head; and
when the first array of magnets attracts the second array of magnets, de-coupling the first component from the pick-and-place head.

17. The method of claim 16, wherein the first component is coupled to the pick-and-place head via at least one of a spring or an air bearing, the at least one of the spring or the air bearing to enable the first component to move relative to the pick-and-place head in response to the magnetic force between the first and second array of magnets.

18. The method of claim 16, wherein the first component is coupled to the pick-and-place head via a vacuum head, the vacuum head to release the first component to de-couple the first component from the pick-and-place head.

19. The method of claim 18, wherein the moving of the first component towards the second component includes moving the first component within a distance of the second component, the distance less than or equal to half a pitch the first array of magnets.

20. The method of claim 16, further including dispensing an optical epoxy between the first component and the second component.
